(19) United States
(12) Patent Application Publication
(10) Pub. No.: US 2023/0053494 A1
(43) Pub. Date: Feb. 23, 2023

(54) SERVICE PROPOSAL SUPPORT SYSTEM AND SERVICE PROPOSAL SUPPORT METHOD

(71) Applicant: Hitachi, Ltd., Tokyo (JP)

(72) Inventors: Etsuko NOMOTO, Tokyo (JP); Tetsuro ADACHI, Tokyo (JP); Tomoko OOMINE, Tokyo (JP)

(73) Assignee: Hitachi, Ltd., Tokyo (JP)

(21) Appl. No.: 17/685,220

(22) Filed: Mar. 2, 2022

(30) Foreign Application Priority Data
Aug. 23, 2021 (JP) 2021-135776

(51) Int. Cl. G06Q 30/00

(52) U.S. Cl. CPC G06Q 30/016

(57) ABSTRACT

Provided is a service proposal support system including an arithmetic device and a storage device. The arithmetic device is configured to calculate, for each of the solutions that are proposable by the proposer, a matching degree between system elements required for each of the solutions and the current system elements of the customer, output, based on the matching degree, one or more candidates for the solution to be proposed to the customer, and output, for at least any one of the one or more candidates for the solution, when a lacking system element exists in the current system elements of the customer compared to system elements required for the at least any one of the one or more candidates for the solution, information indicating the lacking system element.

### CLAIM OF PRIORITY

The present application claims priority from Japanese Patent Application JP2021-135776 filed on Aug. 23, 2021, the content of which is hereby incorporated by reference into this application.

### BACKGROUND OF THE INVENTION

This invention relates to a technology for supporting a proposal of a service in a business activity of, for example, a corporation.

As a technology for supporting a proposal of a solution in a business activity of a corporation, for example, there is a technology as described in JP 2019-212082A. JP 2019-212082 A includes the description “Provided is a digital solution proposal support device including: a storage device configured to store solution information and information on a degree of digitalization maturity; and an arithmetic device configured to: identify, from the solution information, a digital solution and a calculation logic for a customer value at a time of introduction of the digital solution in regard to a problem in a predetermined customer, which has been designated through a predetermined interface; perform trial calculation on the customer value by applying thereto a predetermined attribute value held for the customer as an input value of the identified calculation logic; identify the customer value for presentation to the customer by applying a predetermined coefficient corresponding to the height of a level indicated by the information on the degree of digitalization maturity to a result of the trial calculation; and output the identified digital solution and information on the customer value for presentation to the customer.”

As an example of a technology in which a corporation provides a solution that meets a request from a customer, there is a technology as described in JP 2005-056070 A. JP 2005-056070 A includes the description “For example, a Web server apparatus coupled to a network such as the Internet is provided at a head office being a manufacturing company of a product for sale, and a terminal apparatus at the customer is coupled to the network, to thereby display information on display means. The Web server apparatus is also coupled to a database server provided with a proposal master, a product master, and a customer master. In this case, for example, tens of thousands of “proposals” are registered in the proposal master, and for each of a plurality of items of problems, a point and a deviation value serving as a suitability for presentation are set in terms of each of the proposals. Then, processing for extracting an accurate solution from information on the customer’s request level for each problem is performed, and the solution is presented to the customer, while information based on the customer master is transmitted by electronic mail to the sales company together with the solution.”

As a technology for supporting a proposal of security measures, for example, there is a technology as described in JP 2006-235692 A. JP 2006-235692 A includes the description “Provided is an information processing apparatus including: a product/service information DB in which, for each product/service, an introduction cost, a degree of satisfaction, and a security measure item are associated with degrees of relevance to the product/service; a solution information DB in which a solution is associated with each product/service; means for receiving input of an importance degree of each security measure item, an introduced product/service, and an allowable cost; means for determining a solution that fits the received importance degree through use of the input importance degree, introduced product/service, and allowable cost and pieces of data that are stored in the product/service information DB and the solution information DB; and means for presenting the effect of the measures to be exhibited when the determined solution is introduced.”

### SUMMARY OF THE INVENTION

In JP 2019-212082 A, it is disclosed that a person in charge of a proposer inquiries about the problem of the customer and a degree of digitalization in a current system of the customer, and a proposal of a solution that fits the problem and the current system of the customer is supported.

In JP 2005-056070 A, it is disclosed that a degree of compatibility between the proposal master in which a large number of proposals are registered in advance and information input by the customer is evaluated to present solutions in order of the degree of compatibility.

In JP 2006-235692 A, it is disclosed that a total sum of differences between a current achievement degree and the importance degree for respective items of security measures is calculated as a degree of excess or deficiency, and a combination that minimizes the degree of excess or deficiency is set as an optimum combination.

All the technologies as disclosed in the above-mentioned patent literatures involve offering a proposal conforming to a purpose recognized by the customer and the current system of the customer. However, in an actual case, the customer does not always accurately grasp his or her own purpose (for example, problem to be solved), and hence even when a proposed solution exceeds the purpose recognized by the customer, the proposed solution may actually be determined to be useful to the customer and accepted by the customer. In addition, even when the proposed solution cannot be achieved by the current system of the customer, the proposed solution may also be accepted by the customer in consideration of a cost to compensate a lacking part of the system and a profit to be obtained when the solution is achieved. However, hitherto, it has not been possible to support a proposal that exceeds the purpose recognized by the customer, or to support one proposal that exceeds a range that can be achieved by the current system of the customer together with another proposal of a system improvement for enabling the one proposal.

In order to solve at least one of the foregoing problems, one embodiment of this invention is a service proposal support system, comprising: an arithmetic device; and a storage device, the storage device holding: solution information indicating system elements required for a solution that is proposable in order for a proposer to provide a service to a customer; and system configuration information indicating current system elements of the customer, the arithmetic device being configured to: calculate, for each of the solutions that are proposable by the proposer, a matching degree between system elements required for each of the solutions and the current system elements of the customer; output, based on the matching degree, one or more candidates for the solution to be proposed to the customer; and output, for at least any one of the one or more candidates for the solution, when a lacking system element exists in the current system elements of the customer compared to system elements required for the at least any one of the one or more candidates for the solution, information indicating the lacking system element.

According to the at least one aspect of this invention, it is possible to support a service proposal using a solution to be easily accepted by the customer, which also includes at least one of a solution that does not match the purpose recognized by the customer or a solution that cannot be achieved by the current system of the customer. Objects, configurations, and effects other than those described above are clarified in the following at least one embodiment.

### BRIEF DESCRIPTION OF THE DRAWINGS

FIG. 1 is a flow chart for illustrating an example of main processing in a business activity using a service proposal support system according to the at least one embodiment of this invention.

FIG. 2 is a block diagram for illustrating an example of a configuration of a service proposal support system according to the at least one embodiment of this invention.

FIG. 3 is an explanatory diagram for illustrating an example of a system configuration diagram to be displayed by the service proposal support system according to the at least one embodiment of this invention.

FIG. 4 is a flow chart for illustrating an example of processing for inquiring about an on-site data status through use of the service proposal support system according to the at least one embodiment of this invention.

FIG. 5 is an explanatory table for showing an example of a target-means correspondence table held by the service proposal support system according to the at least one embodiment of this invention.

FIG. 6 is an explanatory table for showing an example of a process-basis data acquisition target table held by the service proposal support system according to the at least one embodiment of this invention.

FIG. 7A and FIG. 7B are flow charts for illustrating an example of processing in which the service proposal support system according to the at least one embodiment of this invention displays the current data acquisition status of the customer.

FIG. 8 is a flow chart for illustrating an example of processing for inquiring about the on-site system through use of the service proposal support system according to the at least one embodiment of this invention.

FIG. 9 is an explanatory table for showing an example of an on-site system selection table held by the service proposal support system according to the at least one embodiment of this invention.

FIG. 10 is a flow chart for illustrating an example of processing in which the service proposal support system according to the at least one embodiment of this invention displays a current on-site system of the customer.

FIG. 11 is a flow chart for illustrating an example of processing for inquiring about the on-site communication means through use of the service proposal support system according to the at least one embodiment of this invention.

FIG. 12 is an explanatory table for showing an example of an on-site communication selection table held by the service proposal support system according to the at least one embodiment of this invention.

FIG. 13 is a flow chart for illustrating an example of processing for inquiring about the usage method and usage purpose of the customer through use of the service proposal support system according to the at least one embodiment of this invention.

FIG. 14 is an explanatory table for showing an example of a usage method selection table held by the service proposal support system according to the at least one embodiment of this invention.

FIG. 15 is an explanatory table for showing an example of a data usage purpose selection table held by the service proposal support system according to the at least one embodiment of this invention.

FIG. 16 is a flow chart for illustrating an example of processing in which the service proposal support system according to the at least one embodiment of this invention displays the data usage method and usage purpose of the customer.

FIG. 17 is an explanatory table for showing an example of a purpose-app correspondence table held by the service proposal support system according to the at least one embodiment of this invention.

FIG. 18 is a flow chart for illustrating an example of processing for inquiring about the on-site problem of the customer based on the problem map through use of the service proposal support system according to the at least one embodiment of this invention.

FIG. 19 is an explanatory map for showing an example of a problem map displayed by the service proposal support system according to the at least one embodiment of this invention.

FIG. 20 is a flow chart for illustrating an example of processing for examining the system level of the customer and proposing a service through use of the service proposal support system according to the at least one embodiment of this invention.

FIG. 21 is an explanatory table for showing an example of a system-level-basis proposal table held by the service proposal support system according to the at least one embodiment of this invention.

FIG. 22 is an explanatory table for showing an example of a system level correspondence table held by the service proposal support system according to the at least one embodiment of this invention.

FIG. 23 is a flow chart for illustrating an example of processing for proposing a future system configuration of the customer and a service targeting the system configuration through use of the service proposal support system according to the at least one embodiment of this invention.

FIG. 24A and FIG. 24B are explanatory views for illustrating an example of a screen displayed by an input/output apparatus of the service proposal support system according to the at least one embodiment of this invention.

FIG. 25A and FIG. 25B are explanatory views for illustrating another example of a screen displayed by the input/output apparatus of the service proposal support system according to the at least one embodiment of this invention.

FIG. 26A and FIG. 26B are explanatory diagrams for illustrating an example of a usage scene in the business activity of the service proposal support system according to the at least one embodiment of this invention.

### DETAILED DESCRIPTION OF THE PREFERRED EMBODIMENTS

Now, at least one embodiment of this invention is described with reference to the accompanying drawings.

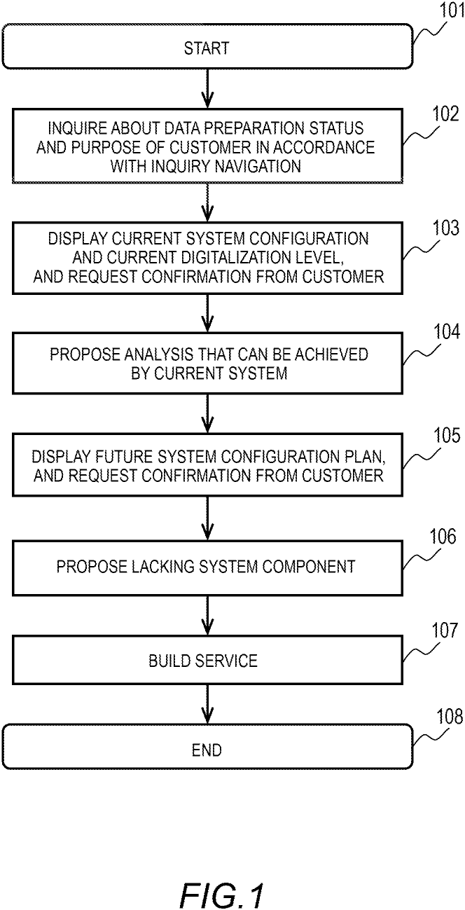

FIG. 1 is a flow chart for illustrating an example of main processing in a business activity using a service proposal support system according to the at least one embodiment of this invention.

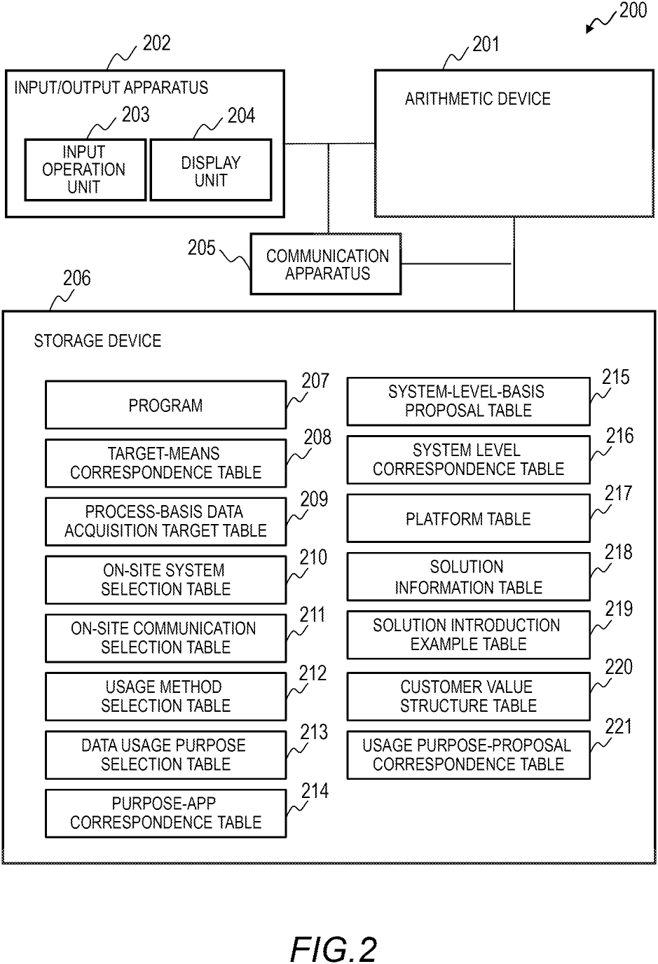

When the processing is started (Step 101), a person in charge at a proposer business operator (the proposer business operator or the person in charge at the proposer business operator may be hereinafter referred to simply as “proposer”) inquires of a person in charge at a customer business operator being a proposal receiver (the customer business operator or the person in charge at the customer business operator may be hereinafter referred to simply as “customer”) about a data preparation status and a purpose in accordance with inquiry navigation provided by a service proposal support system 200 illustrated in FIG. 2, and inputs results thereof to the service proposal support system 200 (Step 102).

Subsequently, the service proposal support system 200 displays a current system configuration and a current digitalization level of the customer based on the input inquiry results, and requests confirmation of the displayed information from the customer (Step 103).

Subsequently, the proposer proposes an analysis that can be achieved by the current system of the customer (Step 104). The proposer further presents a future system configuration plan for the customer, and requests confirmation from the customer (Step 105). The proposer then proposes a lacking system component required for achieving the future system configuration plan for the customer (Step 106). The service proposal support system 200 executes processing described later to support the proposals of Step 104 to Step 106 described above.

When the proposal is accepted, the proposer builds the proposed service (Step 107), and ends the processing (Step 108).

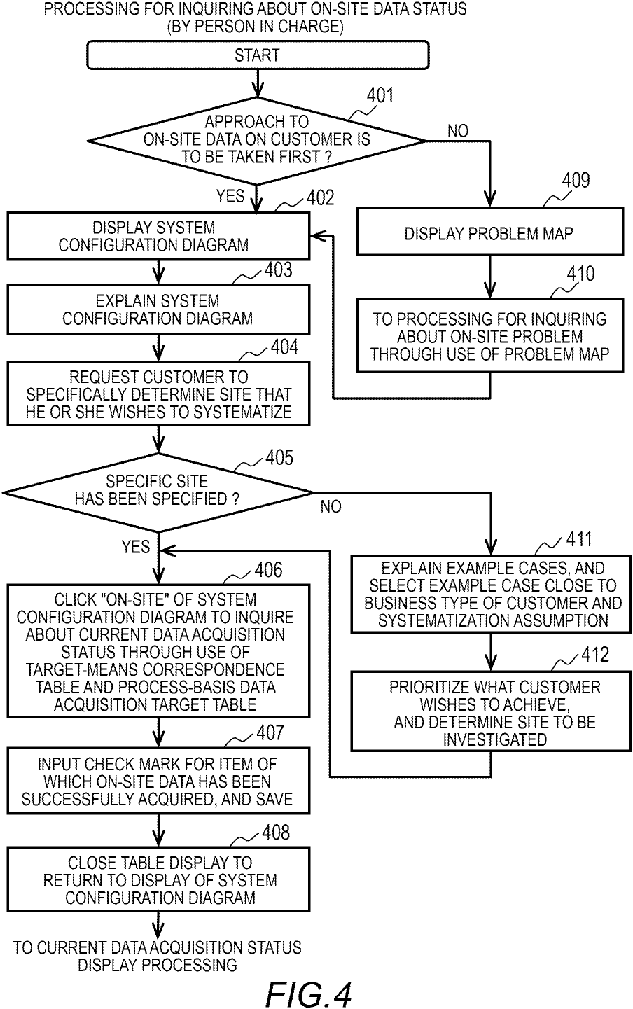

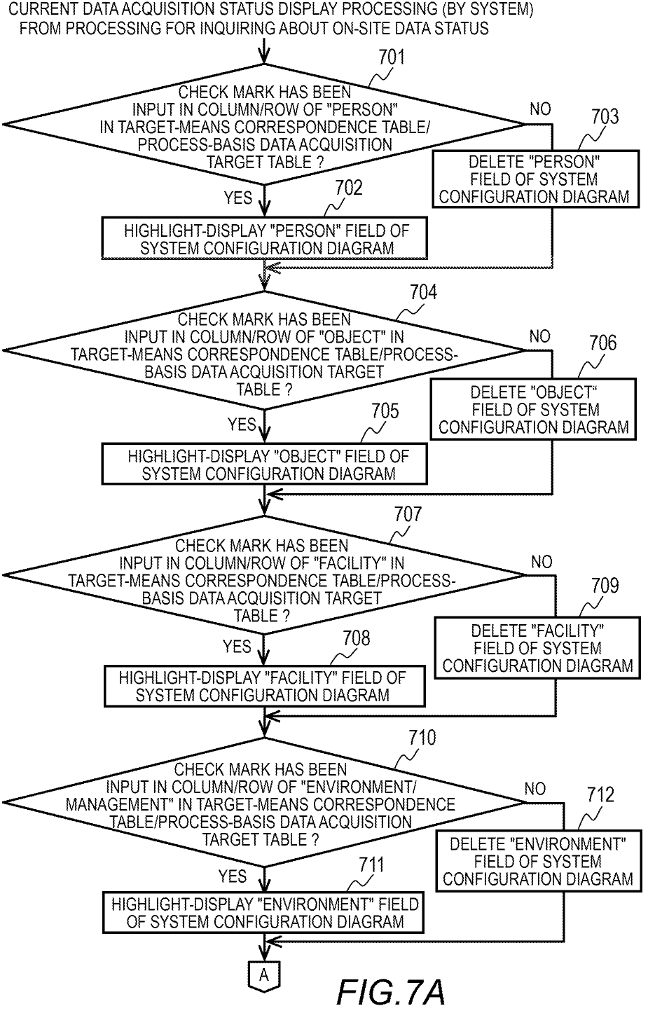

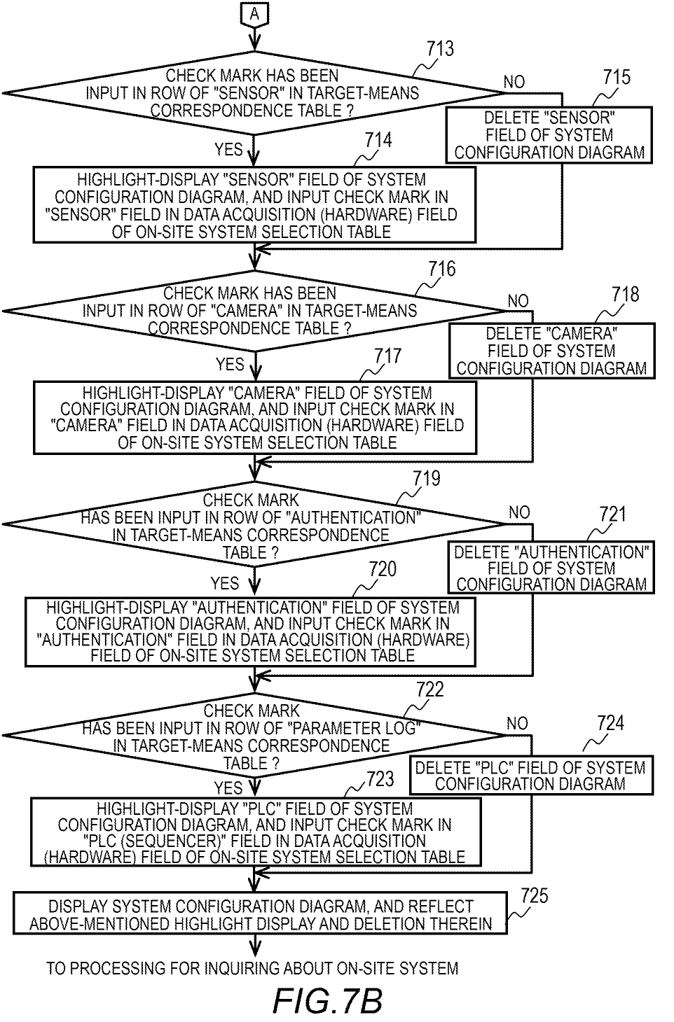

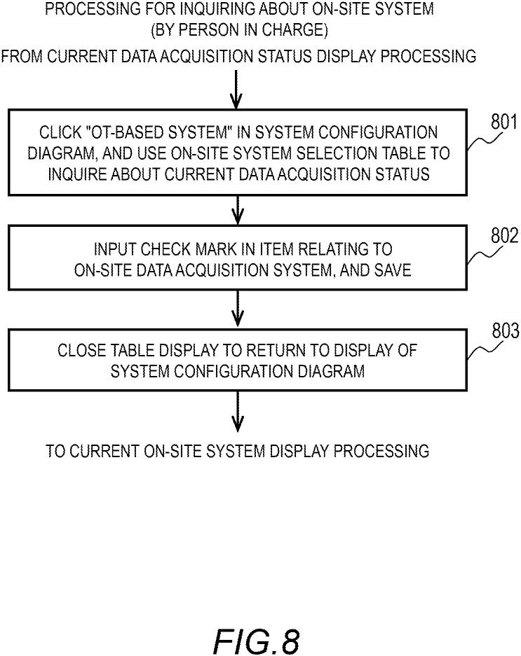

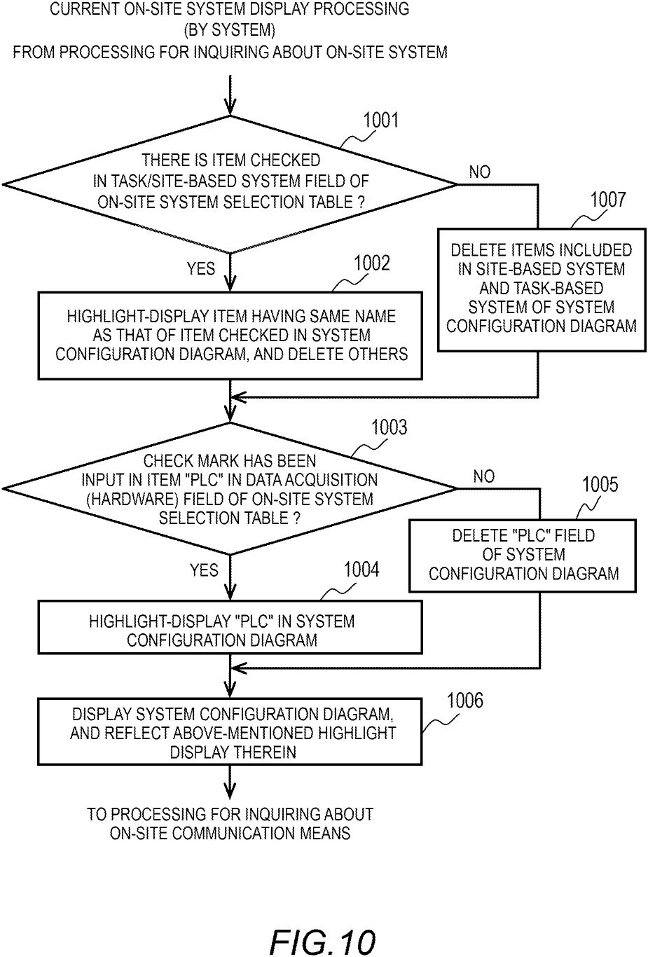

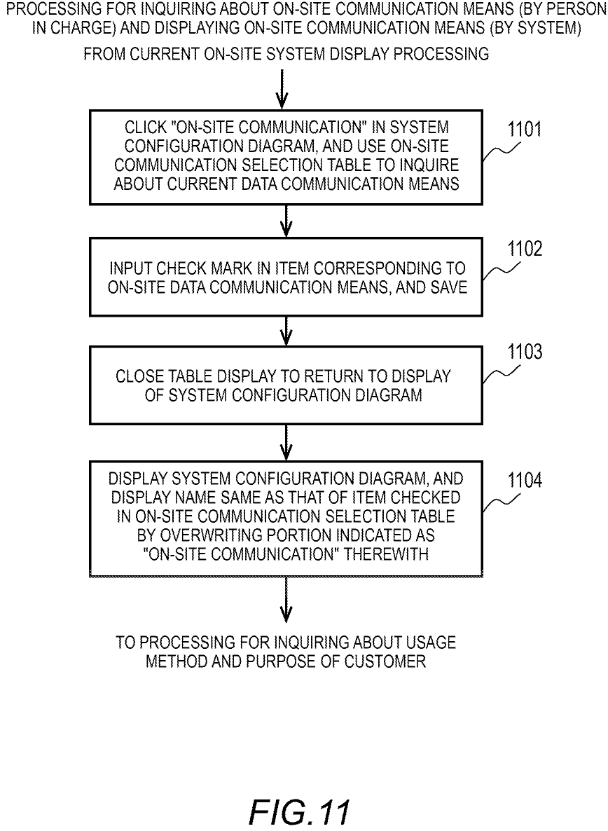

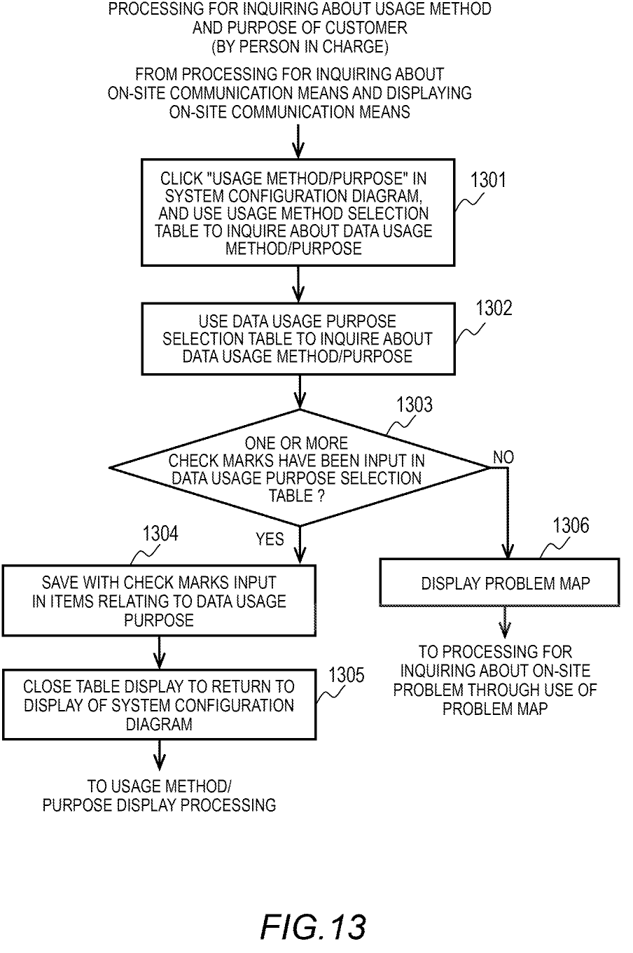

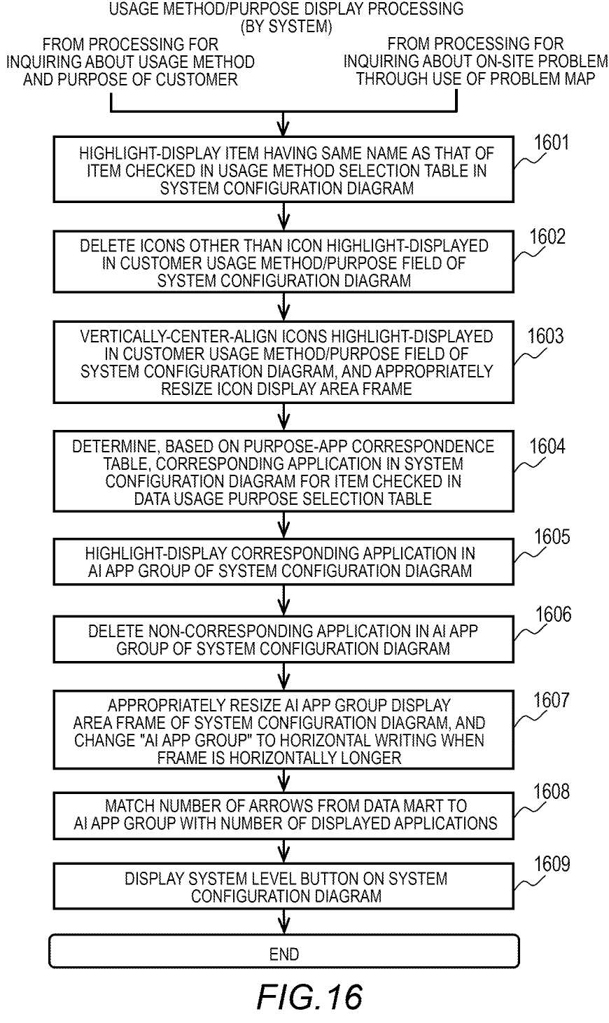

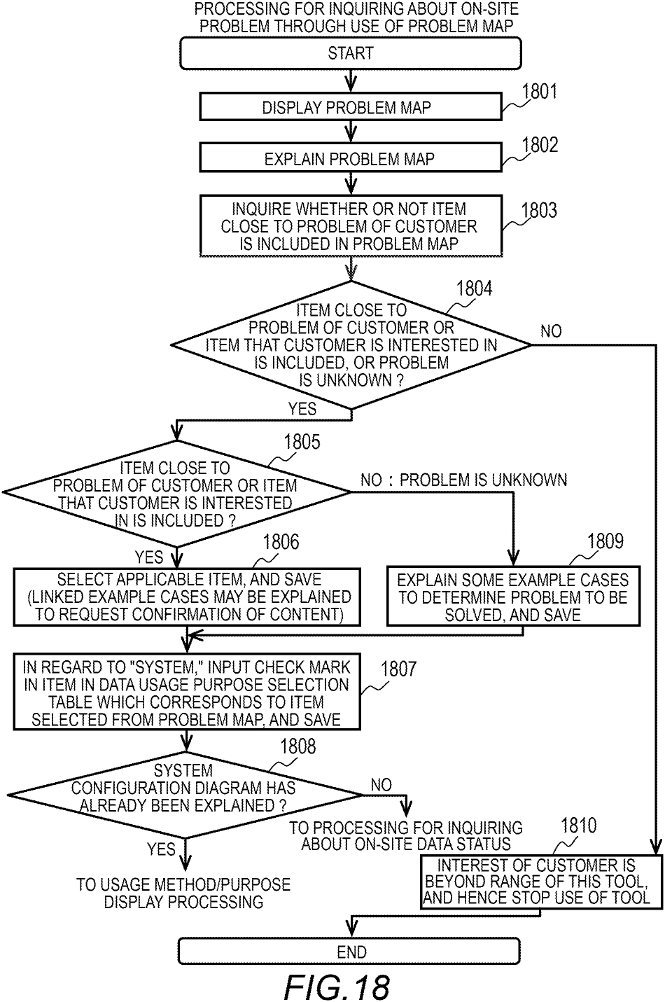

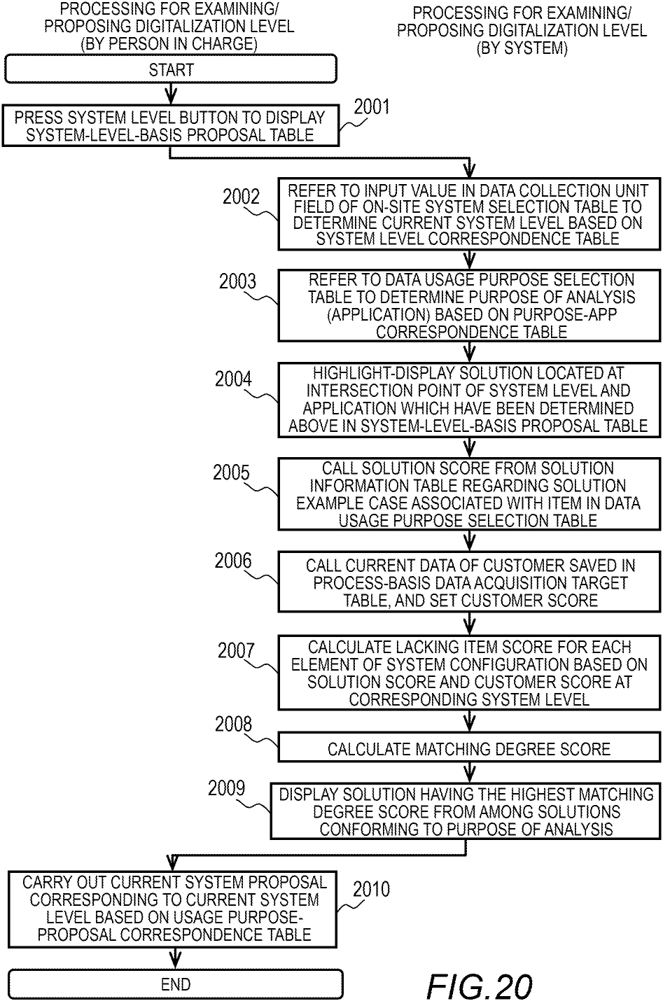

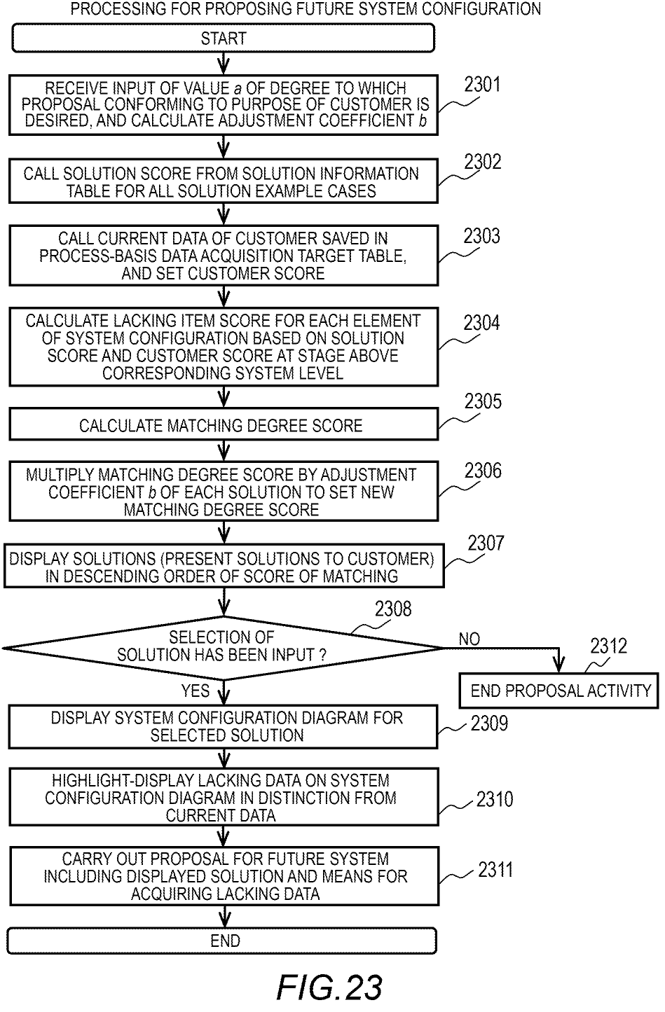

The processing described later with reference to FIG. 4, FIG. 7A, FIG. 7B, FIG. 8, FIG. 10, FIG. 11, FIG. 13, FIG. 16, and FIG. 18 corresponds to Step 102 described above. The processing described later with reference to FIG. 20 corresponds to Step 103 and Step 104 described above. The processing described later with reference to FIG. 23 corresponds to Step 105 and Step 106 described above.

FIG. 2 is a block diagram for illustrating an example of a configuration of the service proposal support system 200 according to the at least one embodiment of this invention.

The service proposal support system 200 according to the at least one embodiment includes an arithmetic device 201, an input/output apparatus 202, a communication apparatus 205, and a storage device 206. The arithmetic device 201 includes, for example, a processor and a main storage device made of a semiconductor such as a dynamic random access memory (DRAM), and executes various kinds of processing in accordance with a program 207 stored in the storage device 206. The processing of the service proposal support system 200, which is described later, is achieved by the arithmetic device 201 executing the program 207.

The storage device 206 is formed of, for example, a large-capacity auxiliary storage device, such as a hard disk drive or a solid-state drive, and is used for holding a program and data. For example, the storage device 206 holds the program 207, a target-means correspondence table 208, a process-basis data acquisition target table 209, an on-site system selection table 210, an on-site communication selection table 211, a usage method selection table 212, a data usage purpose selection table 213, a purpose-app correspondence table 214, a system-level-basis proposal table 215, a system level correspondence table 216, a platform table 217, a solution information table 218, a solution introduction example case table 219, a customer value structure table 220, and a usage purpose-proposal correspondence table 221. The processing executed by the arithmetic device 201 in accordance with the program 207 and each of the tables are described later in detail.

The input/output apparatus 202 includes an input operation unit 203 and a display unit 204. The input operation unit 203 is an apparatus for receiving information input to the service proposal support system 200, and may include, for example, a character input apparatus and a pointing device. The display unit 204 is an apparatus for outputting information processed by the service proposal support system 200, and may include, for example, an image display apparatus.

The communication apparatus 205 is coupled to a communication network (not shown), and can transmit and receive information to and from an apparatus coupled to the communication network.

The arithmetic device 201 can be formed of a single processing unit or a plurality of processing units, and can include a single or a plurality of arithmetic units or a plurality of processing cores. The arithmetic device 201 can be mounted as one or a plurality of central processing units, microprocessors, microcomputers, microcontrollers, digital signal processors, state machines, logic circuits, graphic processing units, chip-on systems, and/or any devices for operating signals based on control instructions.

The function of the service proposal support system 200 can be implemented in a computer system formed of one or more computers including one or more processors and one or more storage devices including a non-transitory storage medium. When the service proposal support system 200 is implemented in a computer system including a plurality of computers, the plurality of computers communicate to/from each other through a communication network. For example, a part of a plurality of functions of the service proposal support system 200 may be implemented in one computer, and another part of the functions may be implemented in another computer. The input/output apparatus 202 may be a terminal apparatus, such as a tablet terminal or a notebook personal computer (PC), which communicates to/from the arithmetic device 201 through the network and the communication apparatus 205.

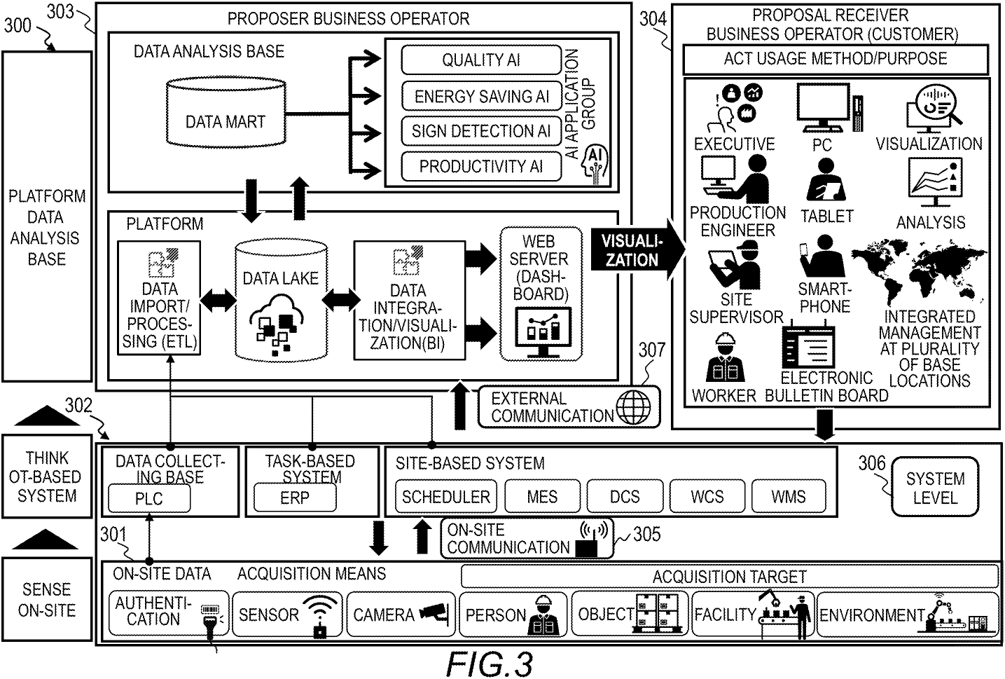

FIG. 3 is an explanatory diagram for illustrating an example of a system configuration diagram to be displayed by the service proposal support system 200 according to the at least one embodiment of this invention.

A system configuration diagram 300 is displayed by the display unit 204 of the service proposal support system 200. The proposer presents the system configuration diagram 300 to the customer, inquires of the customer based on the system configuration diagram 300, and inputs results of the inquiry to the service proposal support system 200. The service proposal support system 200 changes the system configuration diagram 300 depending on the results of the inquiry. In FIG. 3, an example of the system configuration diagram 300 in an initial state, which is to be displayed when the inquiry is to be started, is illustrated.

The system configuration diagram 300 illustrated in FIG. 3 includes an on-site data field 301, an operational technology (OT)-based system field 302, a platform/data analysis base field 303, a usage method/purpose field 304, an on-site communication button 305, a system level button 306, and an external communication button 307.

In the on-site data field 301, information indicating means for acquiring data from the site and acquisition targets is displayed. This is information indicating data acquisition means and acquisition targets that can be used for a service that can be proposed to the customer (that is, can be provided when requested by the customer) by the proposer. For example, authentication (for example, bar code reading), a sensor, and a camera are displayed as the acquisition means, and people, an object, a facility, and an environment are displayed as the acquisition targets. From the acquisition means and acquisition targets that are displayed here, acquisition means and acquisition targets that are held in the current system of the customer are selected as described later.

In the OT-based system field 302, information indicating systems for on-site operation and control is displayed. This is information indicating the systems that can be handled in a service that can be proposed to the customer by the proposer. For example, a data collecting base such as a programmable logic controller (PLC), a task-based system such as enterprise resource planning (ERP), and site-based systems, such as a scheduler, a manufacturing execution system (MES), distributed control system (DCS), warehouse control system (WCS), and a warehouse management system (WMS) are displayed. From the systems displayed here, systems that correspond to the current system of the customer are selected as described later.

In the platform/data analysis base field 303, information indicating a platform and a data analysis base prepared by the proposer for providing a service to the customer is displayed. In the example of FIG. 3, a platform in which data fetched from the OT-based system of the customer is stored in a data lake, and data analyzed by a data analysis base is integrated into the fetched data to be provided through, for example, the Web server by being visualized in a form requested by the customer is displayed. Meanwhile, the data analysis base in which the data acquired from the data lake is temporarily held in a data mart, and data required for analysis therefrom is analyzed by an artificial intelligence (AI) application to return results of the analysis to the data lake is displayed. In addition, AI applications (for example, quality AI, energy saving AI, sign detection AI, and productivity AI) that can be used for data analysis may be displayed.

In the usage method/purpose field 304, information indicating methods and purposes by/for which the customer side is to use a service provided by the proposer to the customer is displayed. This is information indicating, for example, who a specific user of the service is (in other words, who is to see data output by the service), what kind of tool the service is to be used through, and what kind of purpose the service is to be used for. In the example of FIG. 3, an executive, a production engineer, a site supervisor, and a worker of the customer business operator are displayed as the specific users of the service, a PC, a tablet terminal, a smartphone, and an electronic bulletin board are displayed as the tools for using the service, and visualization of data, analysis of data, and integrated management of data at a plurality of base locations are displayed as the usage purposes of the service.

The on-site communication button 305 is operated in order to input information relating to communication on site (for example, in a factory). The system level button 306 is operated in order to input information about a system level. The external communication button 307 is operated in order to input information relating to communication to/from the outside. However, the system level button 306 is not displayed under the initial state, and is displayed when predetermined processing described later is ended as illustrated in FIG. 16.

The system configuration diagram 300 of FIG. 3 is merely an example, and in actuality, the system configuration diagram 300 corresponding to contents of a system prepared by the proposer and contents of services that can be provided through use of the system is displayed.

FIG. 4 is a flow chart for illustrating an example of processing for inquiring about an on-site data status through use of the service proposal support system 200 according to the at least one embodiment of this invention.

The processing illustrated in FIG. 4 corresponds to Step 102 of FIG. 1.

When the processing is started, the person in charge at the proposer business operator determines whether or not an approach to on-site data on the customer is to be taken first (Step 401). When the approach to the on-site data on the customer is to be taken first (YES in Step 401), the proposer causes the service proposal support system 200 to display the system configuration diagram 300 (Step 402) to present the system configuration diagram 300 to the customer, explains the system configuration diagram 300 (Step 403), and requests the customer to specifically determine a site that he or she wishes to systematize (Step 404).

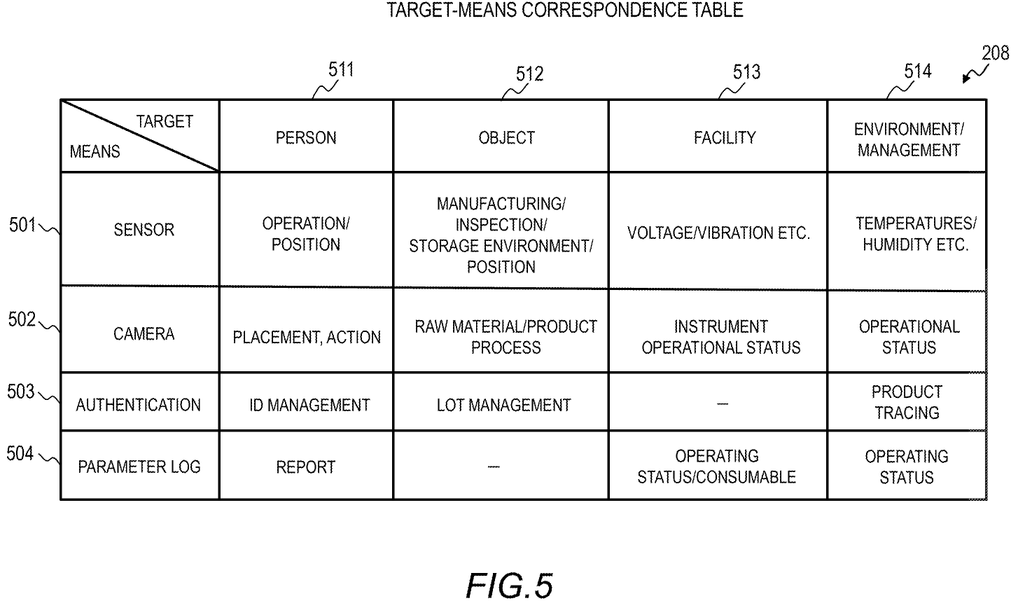

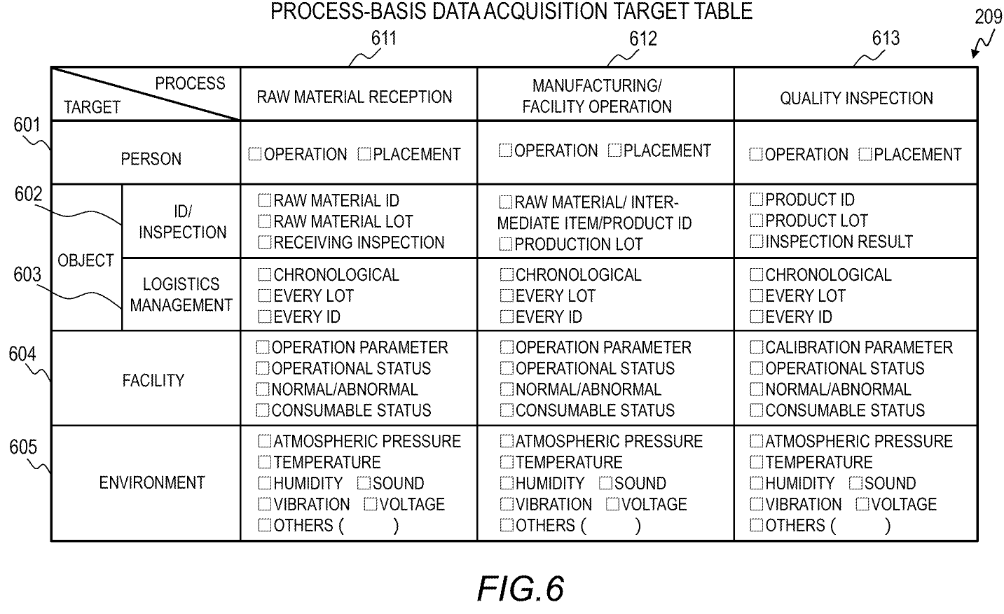

When a specific site is specified by the customer in response to the request (YES in Step 405), the proposer uses the target-means correspondence table 208 and the process-basis data acquisition target table 209 to inquire about a current data acquisition status of the customer (Step 406). For example, the service proposal support system 200 may display the target-means correspondence table 208 and the process-basis data acquisition target table 209 when the proposer clicks the on-site data field 301 of the system configuration diagram 300. Those tables are described later with reference to FIG. 5 and FIG. 6.

As a result of the inquiry performed in Step 406, the proposer inputs a check mark for an item of which on-site data has been successfully acquired in each table, and saves results thereof (Step 407). After that, the service proposal support system 200 ends the display of the tables, and displays the system configuration diagram 300 again (Step 408).

Next, current data acquisition status display processing is executed. This processing is described later with reference to FIG. 7A and FIG. 7B.

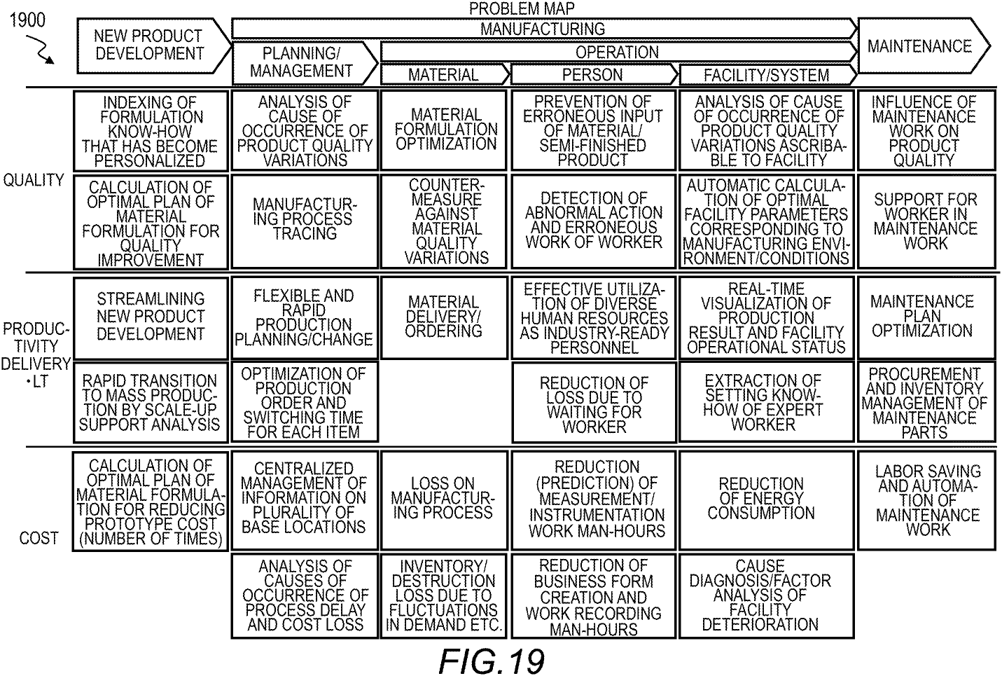

In Step 401, when the approach to the on-site data on the customer is not to be taken first (NO in Step 401), the proposer causes the service proposal support system 200 to display a problem map (Step 409) to present the problem map to the customer, and inquires about an on-site problem (Step 410). The problem map and the inquiry about the on-site problem using the problem map are described later with reference to FIG. 18 and FIG. 19. After that, the process advances to Step 402.

When a specific site is not specified by the customer in response to the request of Step 404 (NO in Step 405), the proposer explains example cases, and selects an example case close to a business type of the customer and a systematization assumption (Step 411). Then, the proposer prioritizes what the customer wishes to achieve, and determines a site to be investigated (Step 412). After that, the process advances to Step 406.

FIG. 5 is an explanatory table for showing an example of the target-means correspondence table 208 held by the service proposal support system 200 according to the at least one embodiment of this invention.

The target-means correspondence table 208 of FIG. 5 shows an example of information identified based on combinations of a data acquisition target (namely, the sensing target) and data acquisition means (namely, sensing means). Specifically, the target-means correspondence table 208 includes a plurality of rows each corresponding to data acquisition means and a plurality of columns each corresponding to a data acquisition target. In the example of FIG. 5, a row 501 corresponds to a sensor, a row 502 corresponds to a camera, a row 503 corresponds to authentication, and a row 504 corresponds to a parameter log. Meanwhile, a column 511 corresponds to a person (for example, worker in a factory when the site is a factory), a column 512 corresponds to an object (for example, product or raw material thereof in the factory), a column 513 corresponds to a facility (for example, manufacturing facility in the factory), and a column 514 corresponds to an environment/management (for example, work environment in the factory). Then, in a cell corresponding to each row and each column, the item of data acquired from the data acquisition target corresponding to the each column by the data acquisition means corresponding to the each row is held.

For example, when, as a result of inquiry from the customer, information that a camera for sensing the placement and action of a worker is installed at a site of a customer corporation is obtained, the items “placement” and “operation” held in the cell of the row 502 and the column 511 are checked.

FIG. 6 is an explanatory table for showing an example of the process-basis data acquisition target table 209 held by the service proposal support system 200 according to the at least one embodiment of this invention.

The process-basis data acquisition target table 209 of FIG. 6 shows an example in which information to be obtained from the customer through the inquiry is described for each process in terms of each data acquisition target. Specifically, the process-basis data acquisition target table 209 includes a plurality of rows each corresponding to a data acquisition target and a plurality of columns each corresponding to a process at the site of the customer. In the example of FIG. 6, a row 601 corresponds to a person, a row 602 corresponds to an ID and inspection of an object, a row 603 corresponds to logistics management, a row 604 corresponds to a facility, and a row 605 corresponds to an environment. Meanwhile, a column 611 corresponds to a process of receiving raw materials in a factory or the like or an object to be stored in a warehouse or the like, a column 612 corresponds to processes of manufacturing and operating a facility, and a column 613 corresponds to a process of inspecting quality. Then, in a cell corresponding to each row and each column, the item of data acquired by the data acquisition means corresponding to the each row in the process corresponding to the each column is held.

For example, as a result of inquiry from the customer, when an operation parameter of the facility for the manufacturing process can be acquired at the site of the customer corporation, the item “operation parameter” held in the row 604 and the column 612 is checked.

FIG. 7A and FIG. 7B are flow charts for illustrating an example of processing in which the service proposal support system 200 according to the at least one embodiment of this invention displays the current data acquisition status of the customer.

When a check mark is input in the column or row corresponding to the “person” in the target-means correspondence table 208 or the process-basis data acquisition target table 209 (for example, in any one of items in the column 511 of FIG. 5 or the row 601 of FIG. 6) (YES in Step 701), the service proposal support system 200 highlight-displays the “person” field in the on-site data field 301 of the system configuration diagram 300 (Step 702), and otherwise (NO in Step 701), the service proposal support system 200 deletes the “person” field (Step 703).

Subsequently, when a check mark is input in the column or row corresponding to the “object” in the target-means correspondence table 208 or the process-basis data acquisition target table 209 (for example, in any one of items in the column 512 of FIG. 5 or the row 602 or row 603 of FIG. 6) (YES in Step 704), the service proposal support system 200 highlight-displays the “object” field in the on-site data field 301 of the system configuration diagram 300 (Step 705), and otherwise (NO in Step 704), the service proposal support system 200 deletes the “object” field (Step 706).

Subsequently, when a check mark is input in the column or row corresponding to the “facility” in the target-means correspondence table 208 or the process-basis data acquisition target table 209 (for example, in any one of items in the column 513 of FIG. 5 or the row 604 of FIG. 6) (YES in Step 707), the service proposal support system 200 highlight-displays the “facility” field in the on-site data field 301 of the system configuration diagram 300 (Step 708), and otherwise (NO in Step 707), the service proposal support system 200 deletes the “facility” field (Step 709).

Subsequently, when a check mark is input in the column or row corresponding to the “environment” in the target-means correspondence table 208 or the process-basis data acquisition target table 209 (for example, in any one of items in the column 514 of FIG. 5 or the row 605 of FIG. 6) (YES in Step 710), the service proposal support system 200 highlight-displays the “environment” field in the on-site data field 301 of the system configuration diagram 300 (Step 711), and otherwise (NO in Step 710), the service proposal support system 200 deletes the “environment” field (Step 712).

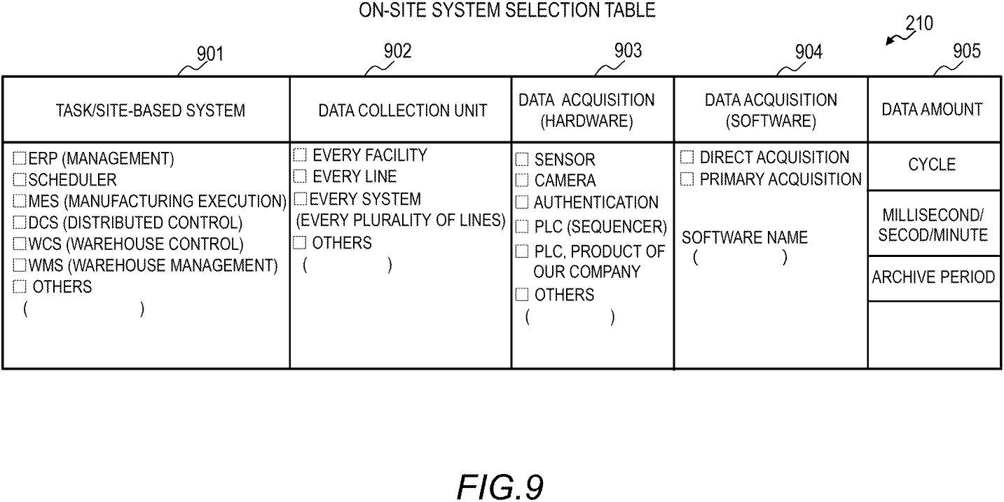

Subsequently, when a check mark is input in the row corresponding to the “sensor” in the target-means correspondence table 208 (for example, in any one of items in the row 501 of FIG. 5) (YES in Step 713), the service proposal support system 200 highlight-displays the “sensor” field in the on-site data field 301 of the system configuration diagram 300, and further inputs a check mark in the “sensor” field in a data acquisition (hardware) field 903 of the on-site system selection table 210, which is described later with reference to FIG. 9 (Step 714), while otherwise (NO in Step 713), the service proposal support system 200 deletes the “sensor” field of the on-site data field 301 (Step 715).

Subsequently, when a check mark is input in the row corresponding to the “camera” in the target-means correspondence table 208 (for example, in any one of items in the row 502 of FIG. 5) (YES in Step 716), the service proposal support system 200 highlight-displays the “camera” field in the on-site data field 301 of the system configuration diagram 300, and further inputs a check mark in the “camera” field in the data acquisition (hardware) field 903 of the on-site system selection table 210 (Step 717), while otherwise (NO in Step 716), the service proposal support system 200 deletes the “camera” field of the on-site data field 301 (Step 718).

Subsequently, when a check mark is input in the row corresponding to the “authentication” in the target-means correspondence table 208 (for example, in any one of items in the row 503 of FIG. 5) (YES in Step 719), the service proposal support system 200 highlight-displays the “authentication” field in the on-site data field 301 of the system configuration diagram 300, and further inputs a check mark in the “authentication” field in the data acquisition (hardware) field 903 of the on-site system selection table 210 (Step 720), while otherwise (NO in Step 719), the service proposal support system 200 deletes the “authentication” field of the on-site data field 301 (Step 721).

Subsequently, when a check mark is input in the row corresponding to the “parameter log” in the target-means correspondence table 208 (for example, in any one of items in the row 504 of FIG. 5) (YES in Step 722), the service proposal support system 200 highlight-displays the “PLC” field in the OT-based system field 302 of the system configuration diagram 300, and further inputs a check mark in the “PLC (sequencer)” field in the data acquisition (hardware) field 903 of the on-site system selection table 210 (Step 723), while otherwise (NO in Step 722), the service proposal support system 200 deletes the “PLC” field of the OT-based system field 302 (Step 724).

Subsequently, the service proposal support system 200 displays the system configuration diagram 300 in which the above-mentioned highlight display and deletion have been reflected (Step 725).

Next, processing for inquiring about the on-site system is executed. This processing is described later with reference to FIG. 8.

Through changes in display including the above-mentioned highlight display and deletion, among the on-site data acquisition means and acquisition targets initially displayed in the system configuration diagram 300, those corresponding to the current system of the customer remain, and the others are deleted. As a result, in the system configuration diagram 300, the on-site data field 301 becomes a field corresponding to the current system of the customer.

The above-mentioned highlight display and deletion are merely an example of a display changing method depending on whether or not a check mark has been input, and another method may be employed. For example, the display may be deleted when a check mark is not input without changing the display when a check mark is input. In another case, instead of deleting the display when a check mark is not input, for example, a so-called gray display may be performed. The same applies to the changes of other display units described below.

FIG. 8 is a flow chart for illustrating an example of processing for inquiring about the on-site system through use of the service proposal support system 200 according to the at least one embodiment of this invention.

First, the proposer uses the on-site system selection table 210 to inquire about the current data acquisition status of the customer (Step 801). For example, the service proposal support system 200 may display the on-site system selection table 210 when the proposer clicks the OT-based system field 302 of the system configuration diagram 300. The on-site system selection table 210 is described later with reference to FIG. 9.

As a result of the inquiry in Step 801, the proposer inputs a check mark in the item corresponding to an on-site data acquisition system in the on-site system selection table 210, and saves a result thereof (Step 802). After that, the service proposal support system 200 ends the display of the table to display the system configuration diagram 300 again (Step 803).

Next, current on-site system display processing is executed. This processing is described later with reference to FIG. 10.

FIG. 9 is an explanatory table for showing an example of the on-site system selection table 210 held by the service proposal support system 200 according to the at least one embodiment of this invention.

The on-site system selection table 210 includes a task/site-based system field 901, a data collection unit field 902, a data acquisition (hardware) field 903, a data acquisition (software) field 904, and a data amount field 905.

In the task/site-based system field 901, a plurality of items are held as options for the task-based system and site-based system of the customer. In the example of FIG. 9, items of ERP, a scheduler, an MES, a DCS, a WCS, a WMS, and others are held. A check mark is input in one or more items corresponding to the current system of the customer based on the results obtained from the customer through the inquiry by the proposer.

In the data collection unit field 902, a plurality of items each indicating a unit of collecting data, that is, which range of the site the data is to be collected based on are held. In the example of FIG. 9, items of every facility, every line, every system, and others are held. A check mark is input in the item corresponding to a data collection unit in the current system of the customer based on the results obtained from the customer through the inquiry by the proposer.

In the data acquisition (hardware) field 903, a plurality of items indicating hardware used for data acquisition are held. In the example of FIG. 9, items of a sensor, a camera, authentication, a PLC, and others are held. In addition, the PLC may include an item indicating whether or not a product of the proposer business operator is used. A check mark is input in the item corresponding to the hardware being used for data acquisition in the current system of the customer based on the results obtained from the customer through the inquiry by the proposer.

In the data acquisition (software) field 904, a plurality of items relating to the software used for data acquisition are held. In the example of FIG. 9, an item indicating whether or not the data acquisition is direct acquisition, an item indicating whether or not the data acquisition is primary acquisition, and an item for inputting a software name are included. A check mark is input in the item corresponding to the software being used for data acquisition in the current system of the customer based on the results obtained from the customer through the inquiry by the proposer.

The data amount field 905 includes an item of information relating to an amount of data to be acquired. In the example of FIG. 9, an item of information indicating a data acquisition cycle and an item of information indicating a data archive period are included. The information on those items is input based on the results obtained from the customer through the inquiry by the proposer.

FIG. 10 is a flow chart for illustrating an example of processing in which the service proposal support system 200 according to the at least one embodiment of this invention displays a current on-site system of the customer.

When a check mark has been input in any of the items in the task/site-based system field 901 of the on-site system selection table 210 (YES in Step 1001), the service proposal support system 200 highlight-displays a field having the same name as that of the checked item among the items included in the system configuration diagram 300, and deletes the others (Step 1002). When a check mark has not been input in any one of the items in the task/site-based system field 901 (NO in Step 1001), the items included in the site-based system and the task-based system of the system configuration diagram are deleted (Step 1007).

Subsequently, when a check mark has been input in the item “PLC” in the data acquisition (hardware) field 903 of the on-site system selection table 210 (YES in Step 1003), the service proposal support system 200 highlight-displays the “PLC” field of the system configuration diagram 300 (Step 1004), and otherwise (NO in Step 1003), deletes the “PLC” field (Step 1005).

Subsequently, the service proposal support system 200 displays the system configuration diagram 300 in which the above-mentioned highlight display and deletion has been reflected (Step 1006).

Next, processing for inquiring about on-site communication means is executed.

FIG. 11 is a flow chart for illustrating an example of processing for inquiring about the on-site communication means through use of the service proposal support system 200 according to the at least one embodiment of this invention.

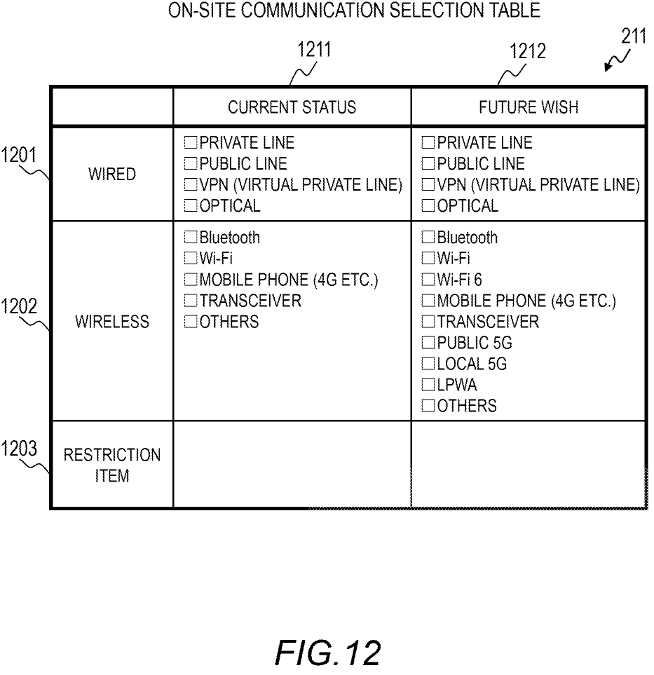

First, the proposer uses the on-site communication selection table 211 to inquire about current data communication means of the customer (Step 1101). For example, the service proposal support system 200 may display the on-site communication selection table 211 when the proposer clicks the on-site communication button 305 of the system configuration diagram 300. The on-site communication selection table 211 is described later with reference to FIG. 12.

As a result of the inquiry performed in Step 1101, the proposer inputs a check mark in the item corresponding to the on-site communication means in the on-site communication selection table 211, and saves a result thereof (Step 1102). After that, the service proposal support system 200 ends the display of the table to display the system configuration diagram 300 again (Step 1103).

In addition, the service proposal support system 200 changes an indication of the on-site communication button 305 of the system configuration diagram 300 to an indication having the same name as that of the item checked in Step 1102 (Step 1104).

Next, processing for inquiring about the usage method and usage purpose of the customer is executed. This processing is described later with reference to FIG. 13.

FIG. 12 is an explanatory table for showing an example of the on-site communication selection table 211 held by the service proposal support system 200 according to the at least one embodiment of this invention.

The on-site communication selection table 211 includes a wired communication field 1201, a wireless communication field 1202, and a restriction item field 1203. In addition, the above-mentioned fields each include a current status field 1211 and a future wish field 1212.

In the current status field 1211 of the wired communication field 1201, a plurality of items corresponding to on-site wired communication means are held. In the example of FIG. 12, items, such as a private line, a public line, a virtual private line (VPN), and an optical communication line, are held. Of those, a check mark is input in the item corresponding to the wired communication means currently used at the site of the customer based on the results obtained from the customer through the inquiry by the proposer.

Items held in the future wish field 1212 of the wired communication field 1201 may be the same as those held in the current field 1211 of the wired communication field 1201, but items corresponding to wired communication means predicted to be available in the future may be added. Of those, a check mark is input in the item corresponding to the wired communication means that the customer wishes to use at the site in the future based on the results obtained from the customer through the inquiry by the proposer.

In the current status field 1211 of the wireless communication field 1202, a plurality of items corresponding to on-site wireless communication means are held. In the example of FIG. 12, items, such as Bluetooth, Wi-Fi, a mobile phone (for example, 4G), a transceiver, and others, are held. Of those, a check mark is input in the item corresponding to the wireless communication means currently used at the site of the customer based on the results obtained from the customer through the inquiry by the proposer.

Items held in the future wish field 1212 of the wireless communication field 1202 may be the same as those held in the current field 1211 of the wireless communication field 1202, but items corresponding to wireless communication means predicted to be available in the future may be added. In the example. of FIG. 12, Wi-Fi 6, public 5G, local 5G, and a low power wide area (LPWA) are added. Of those, a check mark is input in the item corresponding to the wireless communication means that the customer wishes to use at the site in the future based on the results obtained from the customer through the inquiry by the proposer.

In the restriction item field 1203, restriction items on on-site communication are held based on the results obtained from the customer through the inquiry by the proposer. For example, when wireless communication is not possible in a specific area of the site due to an obstacle, information indicating that fact may be held in the restriction item field 1203.

FIG. 13 is a flow chart for illustrating an example of processing for inquiring about the usage method and usage purpose of the customer through use of the service proposal support system 200 according to the at least one embodiment of this invention.

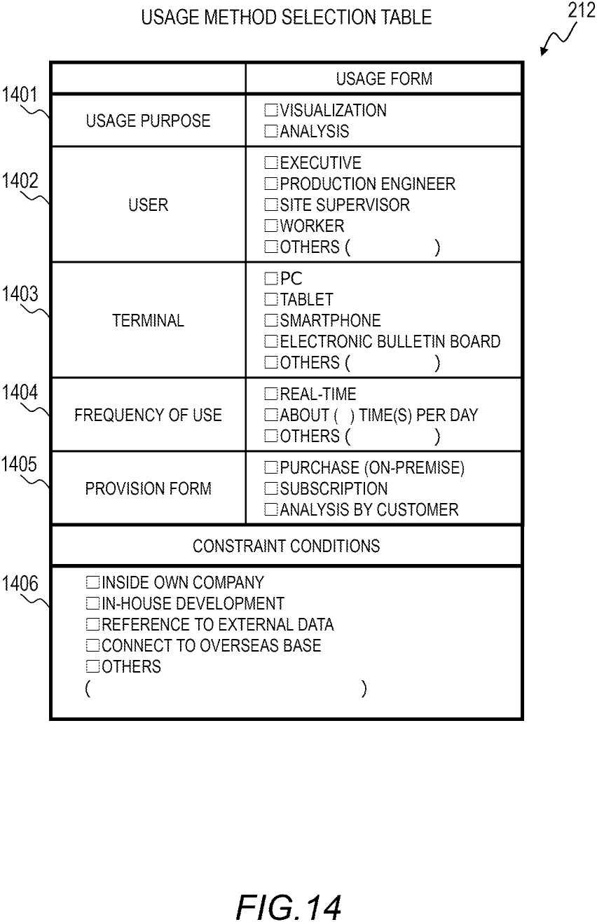

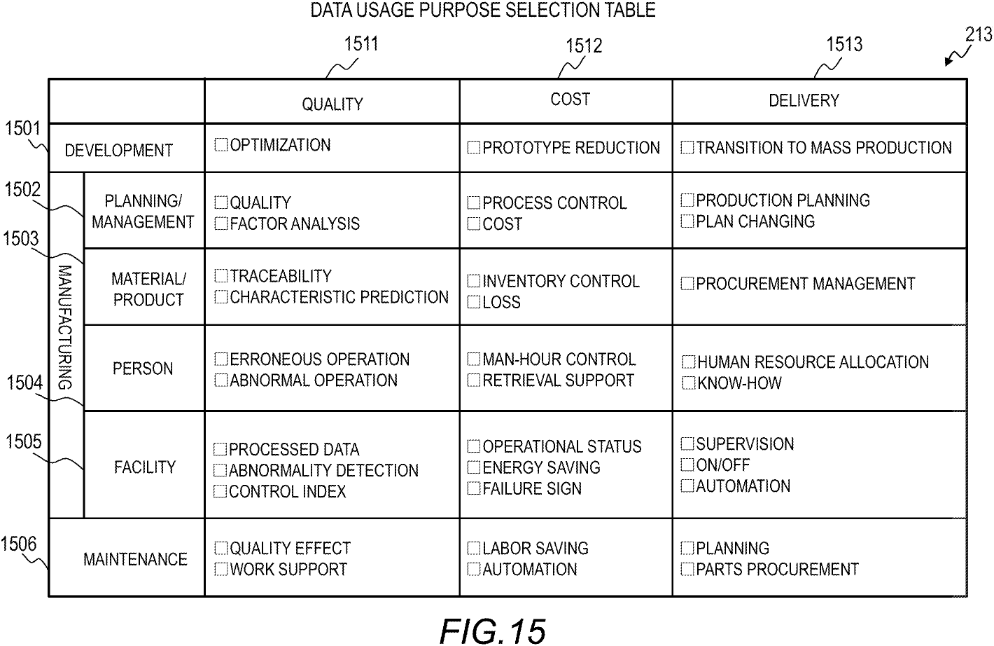

First, the proposer uses the usage method selection table 212 to inquire about data usage method of the customer (Step 1301). Subsequently, the proposer uses the data usage purpose selection table 213 to inquire about the data usage purpose of the customer (Step 1302). For example, the service proposal support system 200 may display the usage method selection table 212 and the data usage purpose selection table 213 when the proposer clicks the usage method/purpose field 304 of the system configuration diagram 300. Those tables are described later with reference to FIG. 14 and FIG. 15.

When one or more check marks are input in the data usage purpose selection table 213 in Step 1302 (YES in Step 1303), the service proposal support system 200 saves the data usage purpose selection table 213 by including the check marks input therein (Step 1304), and ends the display of the table to display the system configuration diagram 300 again (Step 1305). In this case, next, processing for displaying the usage method and usage purpose is executed. This processing is described later with reference to FIG. 16.

When no check marks are input in the data usage purpose selection table 213 in Step 1302 (NO in Step 1303), the service proposal support system 200 displays the problem map (Step 1306). In this case, next, processing for inquiring about an on-site problem through use of the problem map is executed. The problem map and the inquiry processing using the map are described later with reference to FIG. 18 and FIG. 19.

FIG. 14 is an explanatory table for showing an example of the usage method selection table 212 held by the service proposal support system 200 according to the at least one embodiment of this invention.

The usage method selection table 212 includes items indicating usage forms relating to each of a usage purpose (row 1401), a user (row 1402), a terminal (row 1403), a frequency of use (row 1404), and a provision form (row 1405). The usage method selection table 212 further includes an item (row 1406) indicating usage constraint conditions.

In the example of FIG. 14: visualization and analysis are held as items of usage forms regarding the usage purpose; an executive, a production engineer, a site supervisor, a worker, and others are held as items of usage forms regarding the user; a PC, a tablet terminal, a smartphone, an electronic bulletin board, and others are held as items of usage forms regarding the terminal; real-time, a designated daily frequency, and others are held as items of usage forms regarding the frequency of use; and purchase (on-premise), subscription, and analysis on the customer side are held as items of usage forms regarding the provision forms. In addition, as the constraint conditions, items of usage inside the own company, in-house development, reference to external data, required connection to an overseas base, and other are held.

For example, when, as a result of the inquiry performed in Step 1301, information indicating that the customer wishes to analyze data acquired from the site and further the executive of the customer business operator wishes to use results of the analysis about once a month through a PC is obtained, check marks are input in the “analysis” regarding the usage purpose, the “executive” regarding the user, the “PC” regarding the terminal, and “others” regarding the frequency of use (that is, those items are selected), and the information of about once a month is input regarding the frequency of use.

FIG. 15 is an explanatory table for showing an example of the data usage purpose selection table 213 held by the service proposal support system 200 according to the at least one embodiment of this invention.

In the data usage purpose selection table 213, items indicating a plurality of data usage purposes at each stage of a business are held, and the customer can select desired items from among those items. In FIG. 15, as an example, items indicating data usage purposes for managing quality, cost, and delivery (for example, a delivery date) at each of stages from development to maintenance of a manufacturing industry are held.

Specifically, in the example of FIG. 15, the stage of manufacturing is classified into planning/management, a material/product, a person, and a facility. One or more items corresponding to quality management (column 1511), cost management (column 1512) and delivery management (column 1513) are held for each of the development stage (row 1501), the planning/management (row 1502) at the manufacturing stage, the material/product (row 1503) at the manufacturing stage, the person (row 1504) at the manufacturing stage, the facility (row 1505) at the manufacturing stage, and the maintenance stages (row 1506). In Step 1302, a check mark is input in the item corresponding to the data usage purpose of the customer identified based on the results obtained from the customer through the inquiry (that is, those items are selected).

FIG. 16 is a flow chart for illustrating an example of processing in which the service proposal support system 200 according to the at least one embodiment of this invention displays the data usage method and usage purpose of the customer.

The processing of FIG. 16 is executed after the execution of the above-mentioned processing for inquiring about the usage method and usage purpose of the customer illustrated in FIG. 13 or the processing described later for inquiring about the on-site problem through use of the problem map illustrated in FIG. 18.

First, the service proposal support system 200 highlight-displays an icon of an item having the same name as that of the item checked in the usage method selection table 212 among the items in the usage method/purpose field 304 of the system configuration diagram 300 (Step 1601), and deletes icons of the other items (Step 1602).

Subsequently, the service proposal support system 200 aligns the icons highlight-displayed in Step 1601, and appropriately resizes a frame of the usage method/purpose field 304 (Step 1603).

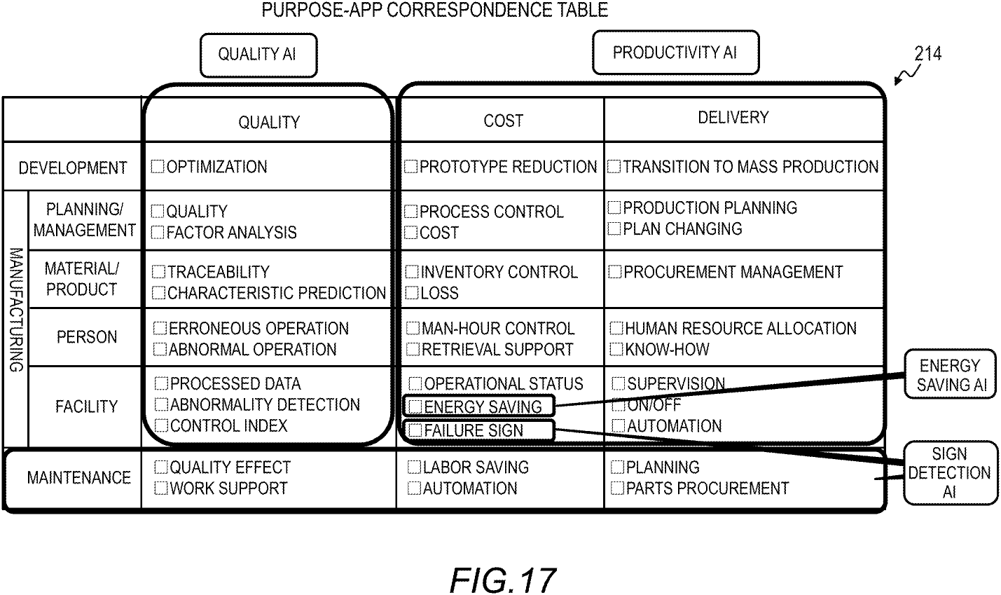

Subsequently, the service proposal support system 200 refers to the purpose-app correspondence table 214 to determine an application corresponding to the item checked in the data usage purpose selection table 213 in an AI application group included in the platform/data analysis base field 303 of the system configuration diagram 300 (Step 1604). The purpose-app correspondence table 214 is described later with reference to FIG. 17.

Subsequently, the service proposal support system 200 highlight-displays the application determined in Step 1604 on the system configuration diagram 300 (Step 1605), and deletes the other applications (Step 1606).

Subsequently, the service proposal support system 200 appropriately resizes a frame of an AI application group display area of the platform/data analysis base field 303 of the system configuration diagram 300 (Step 1607). At this time, the display may be appropriately changed by, for example, changing the representation of “AI app group” to horizontal writing when the frame becomes horizontally longer.

Subsequently, the service proposal support system 200 matches the number of arrows from the data mart to the AI application group in the platform/data analysis base field 303 of the system configuration diagram 300 with the number of displayed AI applications (Step 1608). In other words, when the AI applications are deleted in Step 1606, the corresponding arrows are deleted.

Subsequently, the service proposal support system 200 displays the system level button 306 on the system configuration diagram 300 (Step 1609).

The processing is thus ended.

FIG. 17 is an explanatory table for showing an example of the purpose-app correspondence table 214 held by the service proposal support system 200 according to the at least one embodiment of this invention.

The purpose-app correspondence table 214 includes information for associating the items included in the data usage purpose selection table 213 and the AI applications with each other. In the example of FIG. 17, the items relating to the quality at the development stage and manufacturing stage are associated with quality AI applications. Of the items relating to the cost and the items relating to the delivery at the development stage and manufacturing stage, the “energy saving” item is associated with the energy saving AI application, the “failure sign” item is associated with the sign detection AI application, and the other items are associated with the productivity AI application. In addition, the items relating to the quality, the items relating to the cost, and the items relating to the delivery at the maintenance stage are associated with the sign detection AI application.

For example, in Step 1302 of FIG. 13, when the “optimization” item corresponding to improvement in quality at the development stage is selected from among the items in the data usage purpose selection table 213, in Step 1604 of FIG. 16, the service proposal support system 200 refers to the purpose-app correspondence table 214 to determine the quality AI application corresponding to the “optimization” item. In the at least one embodiment, the application determined here becomes a candidate for a solution proposed by the proposer for the problem of the customer. When a plurality of items are selected in Step 1302, the corresponding application is determined for each of the selected items in the same manner as described above, and is held as a candidate for the proposed solution.

FIG. 18 is a flow chart for illustrating an example of processing for inquiring about the on-site problem of the customer based on the problem map through use of the service proposal support system 200 according to the at least one embodiment of this invention.

The processing illustrated in FIG. 18 is executed subsequently to Step 409 (Step 410) of the processing for inquiring about the on-site data status illustrated in FIG. 4 and subsequently to Step 1306 of the processing for inquiring about the usage method and usage purpose of the customer illustrated in FIG. 13.

First, the service proposal support system 200 displays a problem map 1900 (Step 1801), and the proposer explains the displayed problem map 1900 (Step 1802), and inquires whether or not an item close to the problem of the customer is included in the problem map 1900 (Step 1803). The problem map 1900 is described later with reference to FIG. 19.

As a result of the inquiry, when an item close to the problem of the customer or an item that the customer is interested in is included in the problem map 1900 (YES in Step 1804 and YES in Step 1805), the proposer selects the applicable item, and saves the item in the service proposal support system 200 (Step 1806).

Subsequently, the proposer inputs a check mark in the item in the data usage purpose selection table 213 which corresponds to the item selected from the problem map 1900, and saves the data usage purpose selection table 213 (Step 1807).

When the proposer has already explained the system configuration diagram 300 to the customer at this time point (YES in Step 1808), processing of displaying the usage method and usage purpose, which is illustrated in FIG. 16, is then executed. When the system configuration diagram 300 has not been explained (NO in Step 1808), then the processing steps after Step 402 of the processing for inquiring about the on-site data status, which is illustrated in FIG. 4, are executed.

Meanwhile, when the problem of the customer is still unknown even after the inquiry (YES in Step 1804 and NO in Step 1805), the proposer explains some example cases to the customer to determine the problem to be solved, and saves the problem in the service proposal support system 200 (Step 1809). After that, the process advances to Step 1807.

When the problem of the customer is known but is not included in the problem map 1900 and there are no other items that the customer is interested in, the problem and interest of the customer are beyond a range that can be supported by the service proposal support system 200, and hence the use of the service proposal support system 200 is stopped in the activity for the customer (Step 1810).

FIG. 19 is an explanatory map for showing an example of the problem map 1900 displayed by the service proposal support system 200 according to the at least one embodiment of this invention.

In the problem map 1900, items indicating a plurality of problems at each stage of a business are displayed, and the customer can select the item that the customer recognizes as a problem in his or her own business from among the displayed items. In FIG. 19, as an example, items indicating problems corresponding to quality, cost, and delivery at each of the stages from development to maintenance of the manufacturing industry are displayed.

Specifically, in the example of FIG. 19, the stage of manufacturing is classified into planning/management and operation, and the operation is further classified into a material, a person, and a facility/system. One or more items corresponding to quality management, productivity/delivery management, and cost management are displayed for each of the development stage, the planning/management of the manufacturing stage, the material at the manufacturing stage, the person at the manufacturing stage, the facility/system at the manufacturing stage, and the maintenance stage. In Step 1806 or Step 1809, a check mark is input in the item corresponding to the problem of the customer identified based on the results obtained from the customer through the inquiry.

Each of the items in the problem map 1900 may be associated in advance with the items of the data usage purpose selection table 213. In that case, when the problem of the customer is identified based on the problem map 1900, the corresponding item in the data usage purpose selection table 213 is uniquely identified.

FIG. 20 is a flow chart for illustrating an example of processing for examining the system level of the customer and proposing a service through use of the service proposal support system 200 according to the at least one embodiment of this invention.

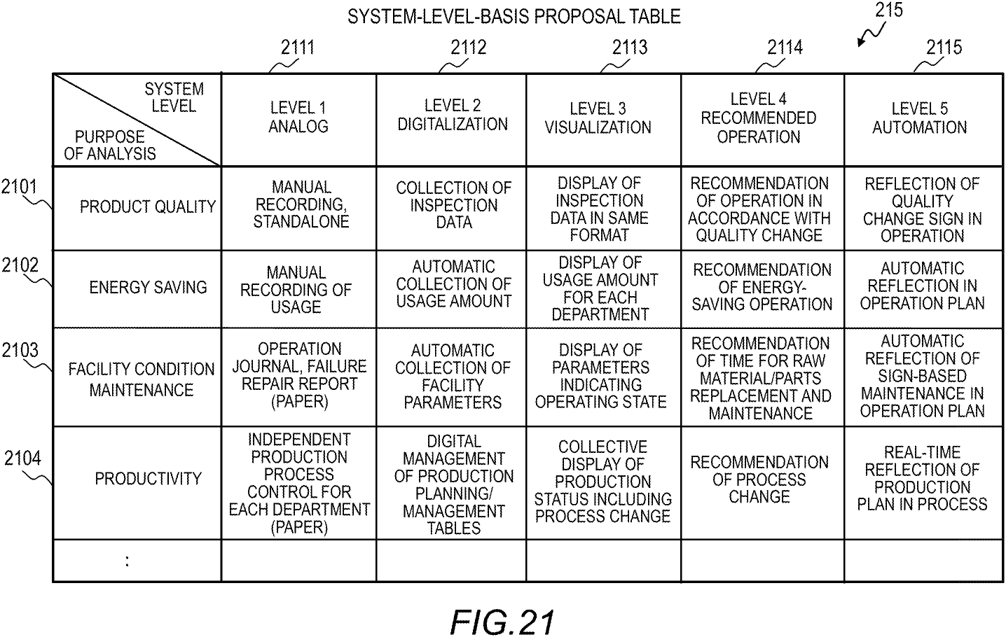

First, the proposer operates the system level button 306 of the system configuration diagram 300 to cause the service proposal support system 200 to display the system-level-basis proposal table 215 (Step 2001). The system-level-basis proposal table 215 is described later with reference to FIG. 21.

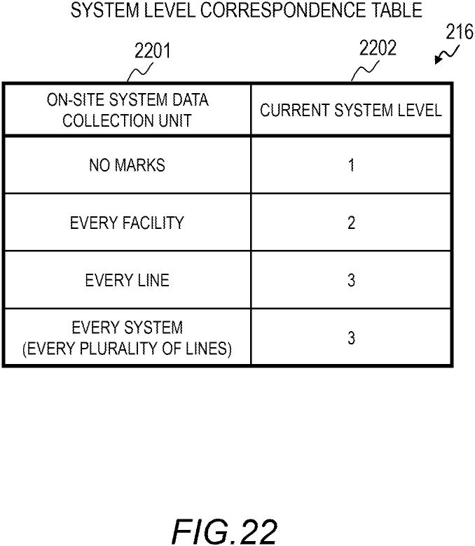

Subsequently, the service proposal support system 200 refers to the input value in the data collection unit field 902 of the on-site system selection table 210 and the system level correspondence table 216 to determine a current system level of the customer, that is, the current digitalization level of the system of the customer (Step 2002). The system level correspondence table 216 is described later with reference to FIG. 22.

Subsequently, the service proposal support system 200 refers to the input value in the data usage purpose selection table 213 and the purpose-app correspondence table 214 to determine the application corresponding to the selected data usage purpose (Step 2003).

Subsequently, the service proposal support system 200 refers to the system-level-basis proposal table 215 to highlight-display a solution described at the intersection point of the row corresponding to the application determined in Step 2003 and the column corresponding to the system level determined in Step 2002 (Step 2004).

Subsequently, the service proposal support system 200 calls a solution score from the solution information table 218 regarding a solution example case corresponding to the item selected in the data usage purpose selection table 213 (Step 2005).

The solution information table 218 is information for defining the solution score of each item (that is, system element) included in the system configuration diagram 300. In this case, the solution score is a score indicating whether or not each item is required for providing each solution, and may be set, for example, to “1” when the each item is required and to “0” when the each item is not required.

In addition, of the items included in the system configuration diagram 300, the on-site data field 301 may include information corresponding to at least one of the target-means correspondence table 208 or the process-basis data acquisition target table 209. For example, for each item corresponding to a pair of the data acquisition target and data acquisition means in the target-means correspondence table 208, the score of “1” may be set when the data of that item is required for providing the solution, and otherwise, the score of “0” may be set. In another case, for each item of data of the acquisition target included in the process-basis data acquisition target table 209, the score of “1” may be set when the data of that item is required for providing the solution, and otherwise, the score of “0” may be set.

Requirements for data and the like to be used may differ depending on the system level, and hence different values may be set depending on the system level as the solution score of the same data item relating to the same solution.

Subsequently, the service proposal support system 200 calls the current data acquisition target of the customer saved in the process-basis data acquisition target table 209, and sets the customer score based thereon (Step 2006).

In this case, the customer score indicates items, such as the purpose of an analysis performed by customer, the current system of the customer, and the current data acquisition target of the customer. For example, the customer score of the corresponding item may be set to “1,” and the customer score of items other than the corresponding item may be set to “0.” For example, of the items included in the process-basis data acquisition target table 209, the item being the current acquisition target as a result of inquiry from the customer is set to have the customer score of “1,” and the item that is not the current acquisition target is set to have the customer score of “0.”

Subsequently, the service proposal support system 200 calculates a lacking item score for each element of the system configuration based on the solution score and the customer score at the corresponding system level (Step 2007).

The lacking item score is a score indicating an item required for providing a solution at the current system level of the customer and an item that is not included in the current system of the customer and the current data acquisition target, that is, an item lacking in the current system of the customer in terms of providing a solution at the current system level of the customer. Specifically, the lacking item score of each item becomes “1” when the solution score of the item is “1” and the customer score is “0,” and otherwise, becomes “0.”

Subsequently, the service proposal support system 200 calculates a matching degree score (Step 2008).

The matching degree score is a ratio of the number of items with the solution score corresponding to the current system level of the customer being “1” and the lacking item score being “0” to the number of items with the solution score being “1” (that is, ratio of the number of system elements required for the solution and included in the current system of the customer to the number of system elements required for the solution). The matching degree score of “1” means that the solution can be provided in the current system of the customer. In addition, even when the matching degree score has a value smaller than “1,” as the value becomes closer to “1,” the less items are to be added to the system of the customer in order to provide the solution, and hence it can be said to be easier to provide the solution. In other words, it is predicted that as the solution has the higher matching degree score, it becomes easier for the customer to accept the service proposal of the solution.

Subsequently, the service proposal support system 200 displays one or more solutions having the matching degree score satisfying a predetermined condition from among the solutions conforming to the purpose of the analysis (Step 2009). For example, only the solution having the highest matching degree score may be displayed, or one or more solutions having a matching degree score higher than a predetermined reference may be displayed. In this case, the purpose of the analysis corresponds to the data usage purpose of the customer, and may correspond to, for example, the application identified based on the purpose-app correspondence table 214.

The proposer carries out a service proposal corresponding to the current system level of the customer (hereinafter referred to also as “current system proposal”) based on the usage purpose-proposal correspondence table 221 (Step 2010).

FIG. 21 is an explanatory table for showing an example of the system-level-basis proposal table 215 held by the service proposal support system 200 according to the at least one embodiment of this invention.

Each row of the system-level-basis proposal table 215 corresponds to the purpose of the analysis. In the example of FIG. 21, a row 2101 corresponds to improvement in product quality, a row 2102 corresponds to energy saving, a row 2103 corresponds to facility condition maintenance, and a row 2104 corresponds to productivity. Those correspond to, for example, the quality AI, the energy saving AI, the sign detection AI, and the productivity AI included in the AI application group, respectively. In actuality, the purpose of an analysis corresponding to another application may be included.

Each column of the system-level-basis proposal table 215 corresponds to the system level (that is, digitalization level of the system). In the example of FIG. 21, a column 2111 to a column 2115 correspond to a system level 1 to a system level 5, respectively. In this case, the system level 2 is a level at which the digitalization of the system has progressed from the system level 1 (that is, level higher by one step), the system level 3 and the system level 4 are levels higher by one step in order, and the system level 5 is a level at which the digitalization has most progressed (that is, the highest level).

In this example, the system level 1 is a level at which information in the system is handled in an analog manner. The system level 2 is a level at which the information in the system is digitalized to be handled as data. The system level 3 is a level at which the digital data is visualized to be presented to an administrator or the like. The system level 4 is a level at which a recommended operation is identified to be presented based on the digital data. The system level 5 is a level at which the operation of the system is automated based on the digital data.

The above-mentioned setting of the digitalization levels of the system is merely an example, and levels other than the above-mentioned levels may be set. For example, further subdivided levels, fewer levels, or levels from different viewpoints may be set.

FIG. 22 is an explanatory table for showing an example of the system level correspondence table 216 held by the service proposal support system 200 according to the at least one embodiment of this invention.

The system level correspondence table 216 includes information for associating the input value of the data collection unit field 902 of the on-site system selection table 210 and the current system level of the customer with each other. In an on-site system data collection unit field 2201, the values that can be selected in the data collection unit field 902 are held, and in a current system level field 2202, the system levels determined when the respective values are selected are held.

In the example of FIG. 22, when no values are selected in the data collection unit field 902, the current system level of the customer is determined to be 1. When “every facility” is selected in the data collection unit field 902 (that is, a check mark is input in that item), the current system level of the customer is determined to be 2. When “every line” or “every system (every plurality of lines)” is selected in the data collection unit field 902, the current system level of the customer is determined to be 3.

FIG. 23 is a flow chart for illustrating an example of processing for proposing a future system configuration of the customer and a service targeting the system configuration through use of the service proposal support system 200 according to the at least one embodiment of this invention.

First, the service proposal support system 200 receives input of a value a indicating a degree to which a proposal conforming to a purpose of the customer is desired, and calculates an adjustment coefficient b (Step 2301). For example, the adjustment coefficient b is calculated so that the adjustment coefficient b becomes larger as the degree to which the customer himself or herself desires the proposal conforming to the purpose of the customer becomes higher.

An example of a method of calculating the adjustment coefficient b is described. For example, the proposer determines the degree to which the customer desires the proposal conforming to the purpose based on the inquiry with respect to the customer, and the value a from the minimum value of 0 to the maximum value of 5 may be input to the service proposal support system 200 depending on the magnitude of the determined degree. Then, the service proposal support system 200 may set the adjustment coefficient “b=1+a/5” for the solution corresponding to the purpose of the customer, and may set the adjustment coefficient b=1 for the other solutions.

Subsequently, the service proposal support system 200 calls the solution score from the solution information table 218 for all solution example cases (Step 2302). This processing step is the same as that of Step 2005 of FIG. 20 except that not only the solution selected through use of the data usage purpose selection table 213 but also the solution scores for all the solutions are called.

At this time, the service proposal support system 200 calls not only the solution score corresponding to the current system level of the customer but also the solution score corresponding to a higher system level (for example, higher by one step). The solution score corresponding to the higher system level called here is to be used in Step 2304 described later.

Subsequently, the service proposal support system 200 calls the current data acquisition target of the customer saved in the process-basis data acquisition target table 209, and sets the customer score based thereon (Step 2303). This processing step is the same as that of Step 2006 of FIG. 20.

Subsequently, the service proposal support system 200 calculates the lacking item score for each element of the system configuration based on the solution score and the customer score at the level above the corresponding system level (Step 2304). This processing step is the same as that of Step 2007 of FIG. 20 except that the solution score corresponding to the system level above the current system level determined in Step 2002 of FIG. 20 is used to calculate the lacking item score for each of all the solutions.

Subsequently, the service proposal support system 200 calculates the matching degree score (Step 2305). Specifically, the service proposal support system 200 calculates the matching degree score by the same method as that of Step 2008 of FIG. 20 for each of all the solutions based on the customer score set in Step 2303 and the lacking item score for each solution calculated in Step 2304.

Subsequently, the service proposal support system 200 calculates a new matching degree score by multiplying the matching degree score by the adjustment coefficient b of each solution (Step 2306). Specifically, the service proposal support system 200 multiplies the matching degree score calculated for the solution corresponding to the purpose of the customer by the adjustment coefficient “b=1 +a/5” or multiplies the matching degree score calculated for another solution by the adjustment coefficient b=1, to thereby calculate a new matching degree score.

Subsequently, the service proposal support system 200 displays the solutions in descending order of the matching degree score, and the proposer presents the solutions to the customer (Step 2307).

When the information for selecting any one of the displayed solutions is input (YES in Step 2308), the service proposal support system 200 displays the system configuration diagram 300 corresponding to the selected solution (Step 2309).

Subsequently, the service proposal support system 200 highlight-displays the data currently lacking in terms of applying the selected solution, on the system configuration diagram 300 in distinction from the currently acquired data (Step 2310).

The proposer carries out a proposal for a future system including the displayed solution and means for acquiring the lacking data (Step 2311).

When the information for selecting one of the solutions displayed in Step 2307 is not input (NO in Step 2308), the proposal activity is ended (Step 2312).

According to the above-mentioned processing of FIG. 23, even when the solution does not correspond to the purpose obtained from the customer through the inquiry, a solution having a higher matching degree with the current system of the customer (that is, solution that can be achieved by the current system or can be achieved by adding a relatively smaller number of items) can be listed as a candidate for the proposal. Such a candidate is considered to be acceptable by the customer due to the smaller number of items to be added for the achievement when the candidate is potentially required therefor even if the candidate does not correspond to the object clearly recognized by the customer.

In addition, as described above, in the processing of FIG. 23, it is also possible to calculate the matching degree score based on the solution score of the system level higher than the current system level of the customer. Thus, even when the solution corresponds to the purpose obtained from the customer through the inquiry but cannot be achieved by the current system of the customer, the solution can be listed as a candidate for the proposal together with the items to be added for the achievement. Such a candidate corresponds to the purpose clearly recognized by the customer, and hence even if there are items lacking in terms of achievement of the purpose, when a burden for achieving the lacking items can be tolerated, the proposal is considered to be acceptable.

Further, according to the processing of FIG. 23, even a solution that does not correspond to the purpose obtained from the customer through the inquiry and cannot be achieved by the current system of the customer may be included in the candidates when the matching degree score is high. For the same reasons as described above, it can be said that the proposal of such a solution is acceptable by the customer.

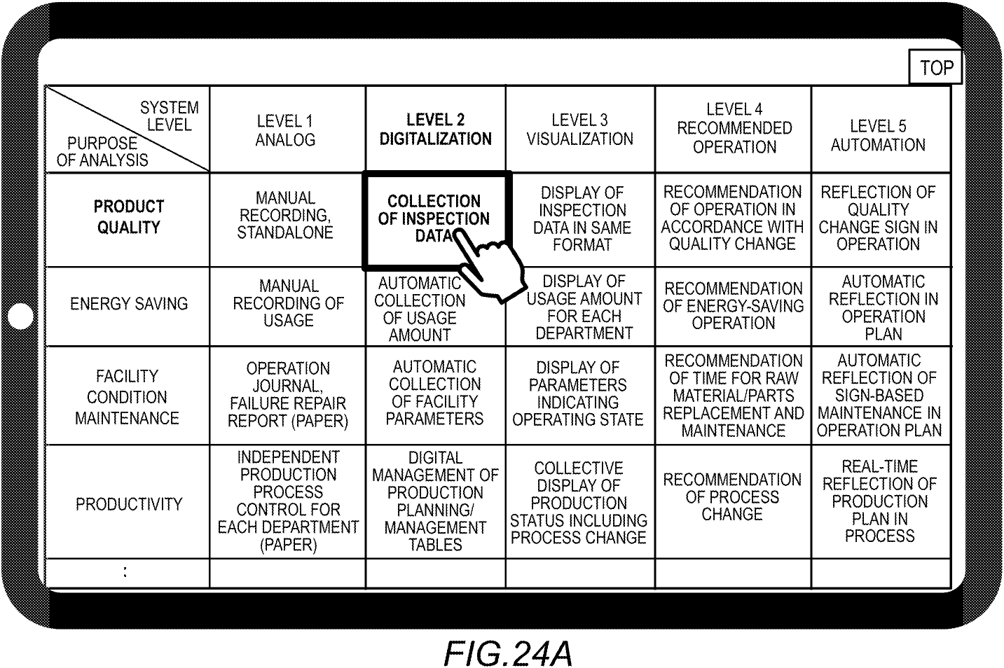

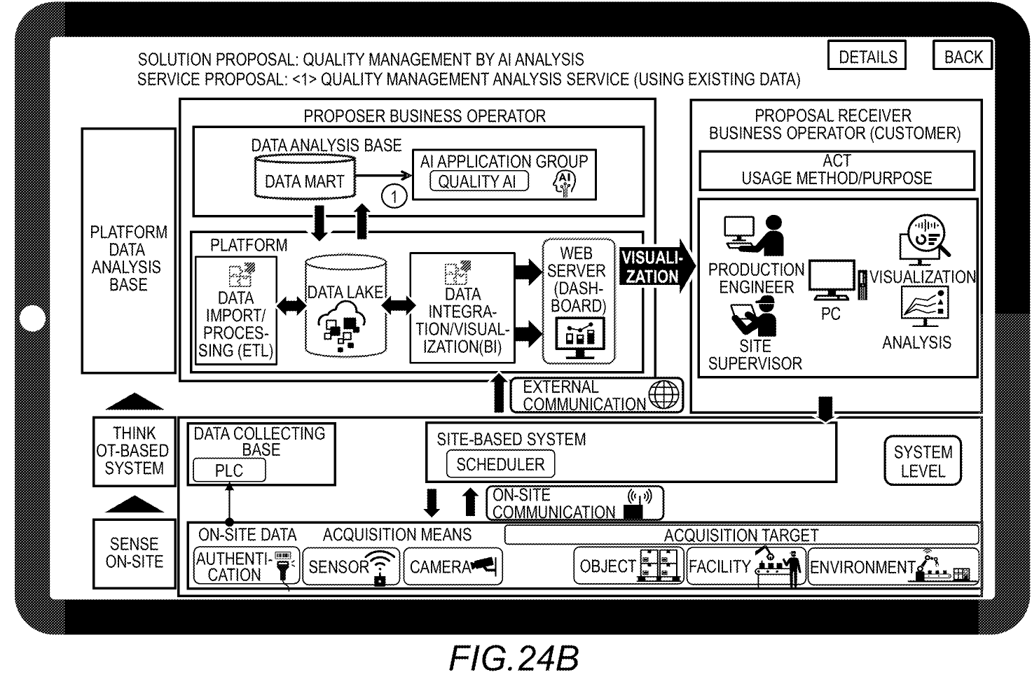

FIG. 24A and FIG. 24B are explanatory views for illustrating an example of a screen displayed by the input/output apparatus 202 of the service proposal support system 200 according to the at least one embodiment of this invention.

Specifically, FIG. 24A is an example of a screen for displaying the system-level-basis proposal table 215 when the processing illustrated in FIG. 20 is performed, and FIG. 24B is an example of a screen displayed when a proposal based on the current system of the customer is offered in conformity with the purpose of the customer through use of results of the processing illustrated in FIG. 20.

In FIG. 24A, an example of a screen displayed when the purpose of the customer is the improvement in product quality and the current system level of the customer is the level 2 is illustrated. In this example, the item “collect inspection data,” which corresponds to the intersection point of the row having the “product quality” as the purpose of the analysis and the column having the “level 2” as the system level, is highlight-displayed. As a result of performing the processing illustrated in FIG. 20 under those conditions, a quality management analysis service for the quality management performed by the quality AI application is proposed through use of the data acquired in the current system of the customer as illustrated in, for example, FIG. 24B.

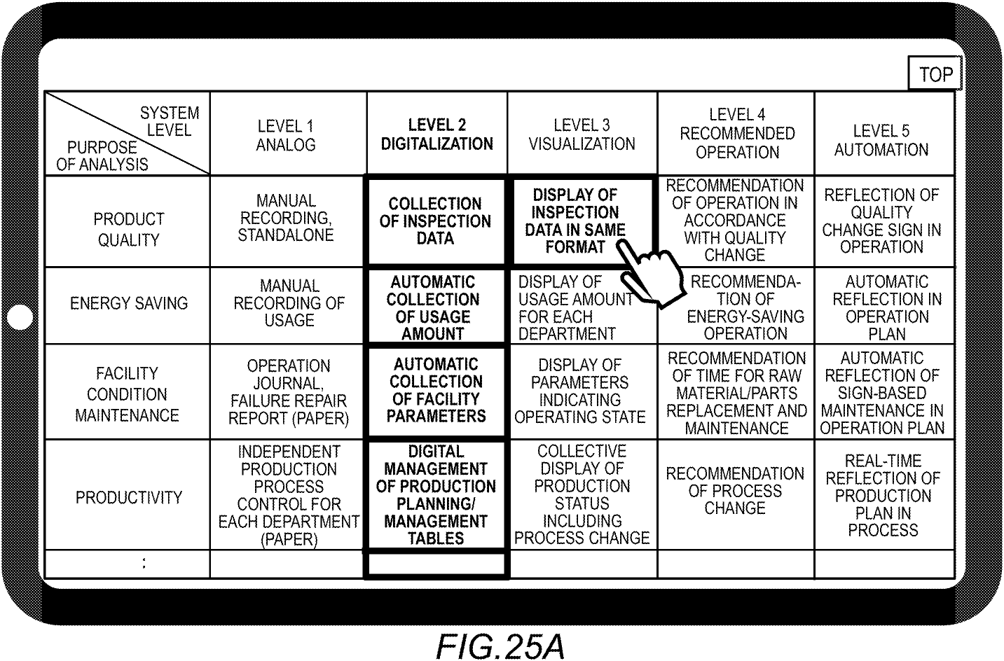

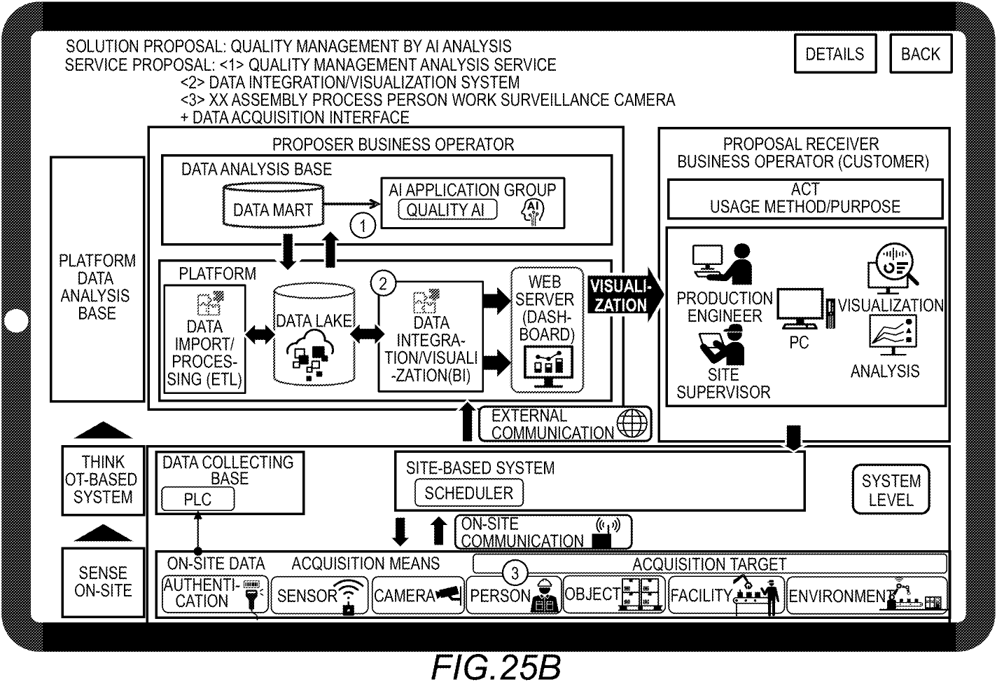

FIG. 25A and FIG. 25B are explanatory views for illustrating another example of a screen displayed by the input/output apparatus 202 of the service proposal support system 200 according to the at least one embodiment of this invention.

Specifically, FIG. 25A is an example of a screen for displaying the system-level-basis proposal table 215 when the processing illustrated in FIG. 23 is performed, and FIG. 25B is an example of a screen displayed when a proposal is offered in consideration of a service that does not correspond to the purpose of the customer and a future system of the customer as well through use of results of the processing illustrated in FIG. 23.

In FIG. 25A, an example of a screen displayed when the purpose of the customer is the improvement in product quality and the current system level of the customer is the level 2 is illustrated. In this example, the item “collect inspection data,” which corresponds to the intersection point of the row having the “product quality” as the purpose of the analysis and the column having the “level 2” as the system level, is highlight-displayed. In addition, in this example, the item “display inspection data in same format,” which corresponds to the intersection point of the row having the “product quality” as the purpose of the analysis and the column having the “level 3” higher than the “level 2” by one step as the system level, may be highlight-displayed.

As a result of performing the processing illustrated in FIG. 23 under those conditions, a quality management analysis service for the quality management performed by the quality AI application is proposed through use of the data acquired in the current system of the customer as illustrated in, for example, FIG. 25B. In addition, as a service corresponding to a system at a level higher by one step, a data integration/visualization system for the quality management performed by the quality AI application is proposed. In addition, it is proposed to add a surveillance camera for work by persons in the assembly process for acquiring data required for that purpose, and to add an interface for acquiring data from the surveillance camera.

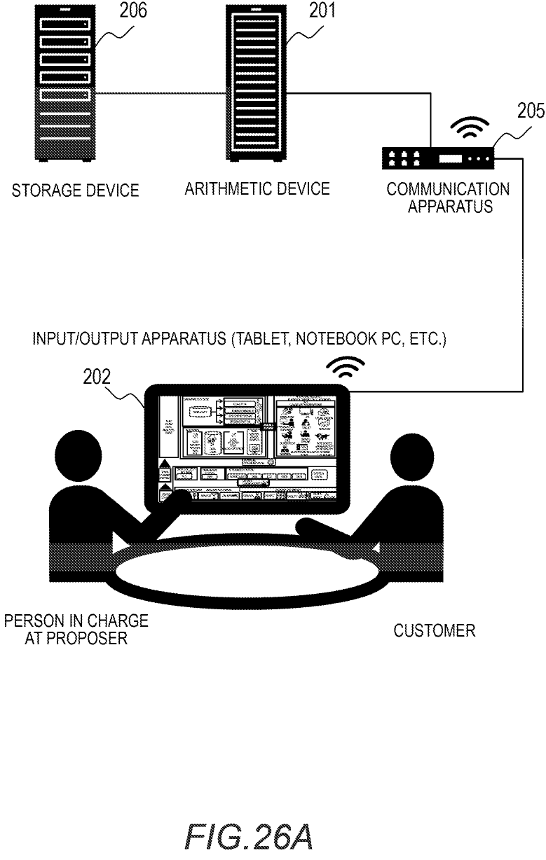

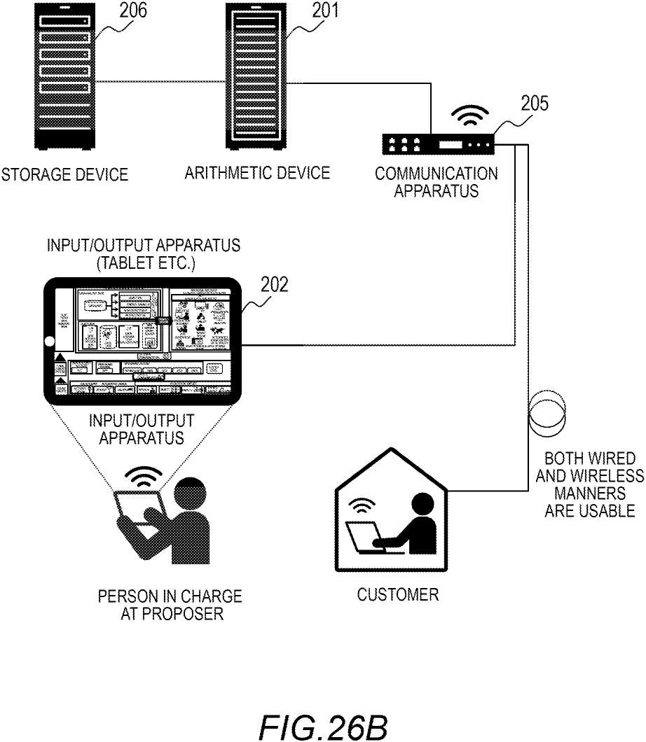

FIG. 26A and FIG. 26B are explanatory diagrams for illustrating an example of a usage scene in the business activity of the service proposal support system 200 according to the at least one embodiment of this invention.

In the example of FIG. 26A, the input/output apparatus 202 is a tablet terminal, a notebook PC, or the like coupled to the arithmetic device 201 through the communication apparatus 205. In this example, the person in charge at the proposer (for example, person in charge of sales or system engineer) who has the input/output apparatus 202 inquires of the customer about the information while presenting the screen displayed on the input/output apparatus 202 directly face-to-face with the customer, and inputs results thereof. Then, when the processing results obtained by the arithmetic device 201 are displayed on the input/output apparatus 202, the person in charge at the proposer proposes a service to the customer based thereon.

In the example of FIG. 26B, the input/output apparatus 202 is a tablet terminal, a notebook PC, or the like coupled to the arithmetic device 201 through the communication apparatus 205. In this example, the person in charge at the proposer who has the input/output apparatus 202 remotely meets the customer through the communication apparatus 205 without directly facing the customer. At this time, the same screen as that displayed on the input/output apparatus 202 may be displayed on a terminal apparatus of the customer. The person in charge at the proposer inquires of the customer about the information while referring to the screen displayed on the input/output apparatus 202 and the terminal apparatus of the customer, and inputs results thereof. Then, when the processing results obtained by the arithmetic device 201 are displayed on, for example, the input/output apparatus 202, the person in charge at the proposer proposes a service to the customer based thereon.

Further, the system according to the at least one embodiment of this invention may be configured as follows.

There is provided a service proposal support system (for example, service proposal support system 200) including: an arithmetic device (for example, arithmetic device 201); and a storage device (for example, storage device 206), the storage device holding: solution information indicating system elements required for a solution that is proposable in order for a proposer to provide a service to a customer (for example, solution information table 218); and system configuration information indicating current system elements of the customer (for example, information on the system configuration of the customer in which the result of the inquiry of Step 101 has been reflected, in particular, information including at least any one of the target-means correspondence table 208 or the process-basis data acquisition target table 209 in which a check mark has been input), the arithmetic device being configured to: calculate, for each of the solutions that are proposable by the proposer, a matching degree between system elements required for the each of the solutions and the current system elements of the customer (for example, processing steps up to Step 2008 of FIG. 20 and processing steps up to Step 2306 of FIG. 23); output, based on the matching degree, one or more candidates for the solution to be proposed to the customer (for example, Step 2009 and Step 2307); and output, for at least any one of the one or more candidates for the solution, when a lacking system element exists in the current system elements of the customer compared to system elements required for the at least any one of the one or more candidates for the solution, information indicating the lacking system element (for example, Step 2310).

With the above-mentioned configuration, it is possible to support a service proposal using a solution to be easily accepted by the customer, which also includes at least one of a solution that does not match the purpose recognized by the customer or a solution that cannot be achieved by the current system of the customer.

In the above-mentioned item (1), the solution is a solution using data acquired in a business of the customer, the storage device further holds: on-site system information indicating a data acquisition status in a current system of the customer (for example, on-site system selection table 210 in which the inquiry result has been input); and system level information indicating a determination criterion for a system level based on the data acquisition status (for example, system level correspondence table 216), the solution information includes, for each system level, information indicating system elements required for a solution that is proposable in order for the proposer to provide a service to the customer, and the arithmetic device is configured to: determine a level of the current system of the customer based on the on-site system information and the system level information (for example, Step 2002); calculate a matching degree between the required system elements corresponding to the level of the current system of the customer among the pieces of solution information and the current system elements of the customer (for example, processing steps up to Step 2008 of FIG. 20); and further calculate a matching degree between the required system elements corresponding to a level above the level of the current system of the customer among the pieces of solution information and the current system elements of the customer (for example, processing steps up to Step 2306 of FIG. 23).

With the above-mentioned configuration, a solution corresponding to the level above the level of the current system of the customer can also be included in the candidates for the proposal.

In the above-mentioned item (2), the level of the system is a level of digitalization of information in the system, and the determination criterion for the level of the system includes information for associating a unit of collecting digitalized data and the level of the system with each other.

With the above-mentioned configuration, it is possible to support the proposal of an appropriate solution in consideration of the system level of the customer.

In the above-mentioned item (1), the solution is a solution using data acquired in a business of the customer, the storage device further holds: data usage purpose information indicating a usage purpose of the data of the customer (for example, data usage purpose selection table 213 in which the inquiry result has been input); and purpose-solution correspondence information for associating the usage purpose of the data and the solution with each other (for example, purpose-app correspondence table 214), and the arithmetic device is configured to: assign a predetermined first weight to a matching degree between system elements required for the solution corresponding to the usage purpose of the data of the customer among the solutions that are proposable by the proposer and the current system elements of the customer (for example, Step 2306); assign a predetermined second weight, which is equal to or smaller than the predetermined first weight, to a matching degree between system elements required for the solution that does not correspond to the usage purpose of the data of the customer among the solutions that are proposable by the proposer and the current system elements of the customer (for example, Step 2306); and output one or more of the solutions having the weighted matching degree ranked higher as the one or more candidates for the solution (for example, Step 2307).

With the above-mentioned configuration, it is possible to support the proposal of an appropriate solution based on a degree to which the customer desires a proposal that meets a purpose recognized by himself or herself.

In the above-mentioned item (1), the solution information includes information indicating necessity of each of a plurality of items corresponding to a data acquisition target and data acquisition means in the system (for example, solution score) as information indicating the system elements required for the solution.

With the above-mentioned configuration, it is possible to appropriately calculate the matching degree between the system elements required for the solution and the current system elements of the customer.

In the above-mentioned item (1), the matching degree between the system elements required for the solution and the current system elements of the customer is a ratio of a number of system elements required for the solution and included in the current system of the customer to a number of system elements required for the solution (for example, ratio of the number of items having the solution score of “1” and the lacking item score of “0” to the number of items having the solution score of “1”).

With the above-mentioned configuration, it is possible to appropriately calculate the matching degree between the system elements required for the solution and the current system elements of the customer.

In the above-mentioned item (1), the service proposal support system further includes an input/output apparatus, the solution is a solution using data acquired in a business of the customer, the storage device further holds: data usage purpose information indicating a usage purpose of the data of the customer; and purpose-solution correspondence information for associating the usage purpose of the data and the solution with each other, and the arithmetic device is configured to: cause the input/output apparatus to display a system configuration diagram including: all solutions that are proposable in order for the proposer to provide the service to the customer; system elements required for each of the solutions; and a usage purpose of data corresponding to the each of the solutions (for example, Step 402); cause, when the system elements of the customer are input, the input/output apparatus to display the system configuration diagram from which system elements other than the system elements of the customer have been deleted (for example, Step 725); and cause, when the usage purpose of the data of the customer is input, the input/output apparatus to display the system configuration diagram from which usage purposes of the data other than the usage purpose of the data of the customer and the solutions other than the solution corresponding to the usage purpose of the data of the customer have been deleted (for example, processing of FIG. 16).

With the above-mentioned configuration, all pieces of information relating to services that can be provided are first displayed to be presented to the customer, and items that are not required are deleted in order based on the information obtained from the customer through the inquiry, to thereby facilitate the acquisition of information from the customer.

This invention is not limited to the at least one embodiment described above, and includes various modification examples. For example, the above-mentioned at least one embodiment has been described in detail for better understanding of this invention, but this invention is not necessarily limited to an invention having all the configurations described above. A part of the configuration of a given embodiment may be replaced with a configuration of another embodiment, or the configuration of another embodiment can be added to the configuration of a given embodiment. It is also possible to add, delete, and replace other configurations for a part of the configuration of each embodiment.

A part or all of each of the above-mentioned configurations, functions, processing modules, processing means, and the like may be implemented by hardware by being designed as, for example, an integrated circuit. Each of the above-mentioned configurations, functions, and the like may be implemented by software by a processor interpreting and executing a program for implementing each function. Information, such as the programs, tables, files, and the like, for implementing each of the functions may be stored in a storage device, such as a non-volatile semiconductor memory, a hard disk drive, or a solid state drive (SSD), or in a computer-readable non-transitory data storage medium, such as an IC card, an SD card, or a DVD.

The control lines and information lines are illustrated to the extent considered to be required for description, and not all the control lines and information lines on the product are necessarily illustrated. In practice, it may be considered that almost all configurations are coupled to each other.

What is claimed is:

1. A service proposal support system, comprising:
an arithmetic device; and
a storage device,
the storage device holding:
solution information indicating system elements required for a solution that is proposable in order for a proposer to provide a service to a customer; and
system configuration information indicating current system elements of the customer,
the arithmetic device being configured to:
calculate, for each of the solutions that are proposable by the proposer, a matching degree between system elements required for each of the solutions and the current system elements of the customer;
output, based on the matching degree, one or more candidates for the solution to be proposed to the customer; and
output, for at least any one of the one or more candidates for the solution, when a lacking system element exists in the current system elements of the customer compared to system elements required for the at least any one of the one or more candidates for the solution, information indicating the lacking system element.

2. The service proposal support system according to claim 1,
wherein the solution comprises a solution using data acquired in a business of the customer,
wherein the storage device further holds:
on-site system information indicating a data acquisition status in a current system of the customer; and
system level information indicating a determination criterion for a level of a system based on the data acquisition status,
wherein the solution information includes, for each level of the system, information indicating system elements required for a solution that is proposable in order for the proposer to provide a service to the customer, and
wherein the arithmetic device is configured to:
determine a level of the current system of the customer based on the on-site system information and the system level information;
calculate a matching degree between the required system elements corresponding to the level of the current system of the customer among the pieces of solution information and the current system elements of the customer; and
further calculate a matching degree between the required system elements corresponding to a level above the level of the current system of the customer among the pieces of solution information and the current system elements of the customer.

3. The service proposal support system according to claim 2,
wherein the level of the system comprises a level of digitalization of information in the system, and
wherein the determination criterion for the level of the system includes information for associating a unit of collecting digitalized data and the level of the system with each other.

4. The service proposal support system according to claim 1,
wherein the solution comprises a solution using data acquired in a business of the customer,
wherein the storage device further holds:
data usage purpose information indicating a usage purpose of the data of the customer; and
purpose-solution correspondence information for associating the usage purpose of the data and the solution with each other, and
wherein the arithmetic device is configured to:
assign a predetermined first weight to a matching degree between system elements required for the solution corresponding to the usage purpose of the data of the customer among the solutions that are proposable by the proposer and the current system elements of the customer;
assign a predetermined second weight, which is equal to or smaller than the predetermined first weight, to a matching degree between system elements required for the solution that does not correspond to the usage purpose of the data of the customer among the solutions that are proposable by the proposer and the current system elements of the customer; and
output one or more of the solutions having the weighted matching degree ranked higher as the one or more candidates for the solution.

5. The service proposal support system according to claim 1, wherein the solution information includes information indicating necessity of each of a plurality of items corresponding to a data acquisition target and data acquisition means in the system as information indicating the system elements required for the solution.

6. The service proposal support system according to claim 1, wherein the matching degree between the system elements required for the solution and the current system elements of the customer comprises a ratio of a number of system elements required for the solution and included in the current system of the customer to a number of system elements required for the solution.

7. The service proposal support system according to claim 1, further comprising an input/output apparatus,
wherein the solution comprises a solution using data acquired in a business of the customer,
wherein the storage device further holds:
data usage purpose information indicating a usage purpose of the data of the customer; and
purpose-solution correspondence information for associating the usage purpose of the data and the solution with each other, and
wherein the arithmetic device is configured to:
cause the input/output apparatus to display a system configuration diagram including:
all solutions that are proposable in order for the proposer to provide the service to the customer;
system elements required for each of the solutions; and
a usage purpose of data corresponding to the each of the solutions;
cause, when the system elements of the customer are input, the input/output apparatus to display the system configuration diagram from which system elements other than the system elements of the customer have been deleted; and
cause, when the usage purpose of the data of the customer is input, the input/output apparatus to display the system configuration diagram from which usage purposes of the data other than the usage purpose of the data of the customer and the solutions other than the solution corresponding to the usage purpose of the data of the customer have been deleted.

8. A service proposal support method to be executed by a computer system,
the computer system comprising:
an arithmetic device; and
a storage device,
the storage device holding:
solution information indicating system elements required for a solution that is proposable in order for a proposer to provide a service to a customer; and
system configuration information indicating current system elements of the customer,
the service proposal support method comprising:
a first step of calculating, by the arithmetic device, for each of the solutions that are proposable by the proposer, a matching degree between system elements required for the each of the solutions and the current system elements of the customer;
a second step of outputting, by the arithmetic device, based on the matching degree, one or more candidates for the solution to be proposed to the customer; and
a third step of outputting, by the arithmetic device, for at least any one of the one or more candidates for the solution, when a lacking system element exists in the current system elements of the customer compared to system elements required for the at least any one of the one or more candidates for the solution, information indicating the lacking system element.

9. The service proposal support method according to claim 8,
wherein the solution comprises a solution using data acquired in a business of the customer,
wherein the storage device further holds:
on-site system information indicating a data acquisition status in a current system of the customer; and
system level information indicating a determination criterion for a level of a system based on the data acquisition status,
wherein the solution information includes, for each level of the system, information indicating system elements required for a solution that is proposable in order for the proposer to provide a service to the customer, and
wherein the first step comprises:
determining, by the arithmetic device, a level of the current system of the customer based on the on-site system information and the system level information;
calculating, by the arithmetic device, a matching degree between the required system elements corresponding to the level of the current system of the customer among the pieces of solution information and the current system elements of the customer; and
further calculating, by the arithmetic device, a matching degree between the required system elements corresponding to a level above the level of the current system of the customer among the pieces of solution information and the current system elements of the customer.

10. The service proposal support method according to claim 9,
wherein the level of the system comprises a level of digitalization of information in the system, and
wherein the determination criterion for the level of the system includes information for associating a unit of collecting digitalized data and the level of the system with each other.

11. The service proposal support method according to claim 8,
wherein the solution comprises a solution using data acquired in a business of the customer,
wherein the storage device further holds:
data usage purpose information indicating a usage purpose of the data of the customer; and
a purpose-solution correspondence information for associating the usage purpose of the data and the solution with each other,
wherein the first step comprises:
assigning, by the arithmetic device, a predetermined first weight to a matching degree between system elements required for the solution corresponding to the usage purpose of the data of the customer among the solutions that are proposable by the proposer and the current system elements of the customer; and
assigning, by the arithmetic device, a predetermined second weight, which is equal to or smaller than the predetermined first weight, to a matching degree between system elements required for the solution that does not correspond to the usage purpose of the data of the customer among the solutions that are proposable by the proposer and the current system elements of the customer, and
wherein the second step comprises outputting, by the arithmetic device, one or more of the solutions having the weighted matching degree ranked higher as the one or more candidates for the solution.

12. The service proposal support method according to claim 8, wherein the solution information includes information indicating necessity of each of a plurality of items corresponding to a data acquisition target and data acquisition means in the system as information indicating the system elements required for the solution.

13. The service proposal support method according to claim 8, wherein the matching degree between the system elements required for the solution and the current system elements of the customer comprises a ratio of a number of system elements required for the solution and included in the current system of the customer to a number of system elements required for the solution.

14. The service proposal support method according to claim 8,
wherein the computer system further includes an input/output apparatus,
wherein the solution comprises a solution using data acquired in a business of the customer,
wherein the storage device further holds:
data usage purpose information indicating a usage purpose of the data of the customer; and
purpose-solution correspondence information for associating the usage purpose of the data and the solution with each other, and
wherein the service proposal support method further comprises the steps of:
causing, by the arithmetic device, the input/output apparatus to display a system configuration diagram including:
all solutions that are proposable in order for the proposer to provide the service to the customer;
system elements required for each of the solutions; and
a usage purpose of data corresponding to the each of the solutions;
causing, by the arithmetic device, when the system elements of the customer are input, the input/output apparatus to display the system configuration diagram from which system elements other than the system elements of the customer have been deleted; and
causing, by the arithmetic device, when the usage purpose of the data of the customer is input, the input/output apparatus to display the system configuration diagram from which usage purposes of the data other than the usage purpose of the data of the customer and the solutions other than the solution corresponding to the usage purpose of the data of the customer have been deleted.
